(19) United States
(12) Patent Application Publication
(10) Pub. No.: US 2024/0088990 A1
(43) Pub. Date: Mar. 14, 2024

(54) ORBITAL ANGULAR MOMENTUM TRANSMITTER CIRCLE SELECTION

(71) Applicant: QUALCOMM Incorporated, San Diego, CA (US)

(72) Inventors: Danlu ZHANG, San Diego, CA (US); Min HUANG, Beijing (CN); Yu ZHANG, San Diego, CA (US); Hao XU, Beijing (CN)

(21) Appl. No.: 18/263,122

(22) PCT Filed: Apr. 2, 2021
(86) PCT No.: PCT/CN2021/085228

§ 371 Date: Jul. 26, 2023

(51) Int. Cl. H04B 7/165; H04L 5/00

(52) U.S. Cl. CPC H04B 7/165; H04L 5/0048

(57) ABSTRACT

Methods, systems, and devices for wireless communications are described. A first device (e.g., a base station) may transmit reference signals to a second device (e.g., a user equipment (UE)) via transmitter antenna circles. The second device may receive and measure the reference signals via corresponding receiver antenna circles. Both the transmitter antenna circles and the in receiver antenna circles may include a center antenna circle and one or more peripheral antenna circles. The second device may transmit channel gain measurements to the first device based on measuring the reference signals. The first device may determine orbital angular momentum (OAM) modes, a power loading scheme, or both for the transmitter antenna circles based on the channel gain measurements. The first device may transmit OAM transmissions to the second device based on the determined OAM modes, the power loading scheme, or both. The OAM transmissions may have different OAM states, polarizations, or both.

### CROSS REFERENCE

The present Application is a 371 national stage filing of International PCT Application No. PCT/CN2021/085228 by ZHANG et al. entitled “ORBITAL ANGULAR MOMENTUM TRANSMITTER CIRCLE SELECTION,” filed Apr. 2, 2021, which is assigned to the assignee hereof, and which is expressly incorporated by reference in its entirety herein.

### FIELD OF TECHNOLOGY

The following relates to wireless communications, including orbital angular momentum (OAM) transmitter circle selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Efficient techniques for transmission of information in such systems is desirable in order to enhance system throughput and reliability.

### SUMMARY

The described techniques relate to improved methods, systems, devices, and apparatuses that support orbital angular momentum transmitter circle selection. Generally, the described techniques provide for enhanced orbital angular momentum (OAM) multiplexing procedures. In some implementations, a first device, such as a transmitting device, and a second device, such as a receiving device, may each be equipped with one or more antenna circles (e.g., uniform circular arrays (UCAs)). The one or more antenna circles may include a center antenna node, center antenna element, center circle, or center antenna array and one or more peripheral antenna circles that enable the first device and the second device to communicate according to one or more OAM modes over the one or more antenna circles. For example, the one or more antenna circles may enable the first and second devices to transmit and receive multiplexed OAM communications. Such multiplexed OAM communications may include multiple OAM waveforms with different OAM states, polarizations, or both.

In some aspects, a first device (e.g., a user equipment (UE), base station, integrated access and backhaul (IAB) node, relay node) or a second device (e.g., a UE, base station, IAB node, relay node), or both may determine a transmission scheme for the first device to use for transmitting messages to the second device. For example, the first device, or the second device, or both may be configured to determine which OAM mode may be transmitted by which antenna circle of the first device (e.g., a transmitter circle). In some cases, the second device may select a transmitter circle (e.g., select a transmitter circle preferred by the second device) for each OAM mode and the second device may transmit a report to the first device that indicates the transmitter circle the second device selected for each OAM mode. The first device may transmit a message over at least one OAM mode via at least one transmitter circle associated with the at least one OAM mode, in some cases, based on the report from the second device. Additionally, or alternatively, the first device may perform a power-sharing procedure between transmitter circles based on the report from the second device (e.g., in accordance with a power loading scheme for the transmitter circles). In some cases, the second device may determine one or more communication parameters associated with the second device, the first device, or both such as one or more channel parameters (e.g., path loss, communications distance) or one or more receiver parameters (e.g., receiver antenna circle radius). The second device may transmit an indication of the one or more parameters to the first device, which the first device may use to select one or more transmitter circles for one or more OAM modes. The first device may transmit a message over at least one OAM mode via at least one corresponding transmitter circle, selected by the first device.

A method for wireless communications at a first device is described. The method may include receiving, from a second device, an indication of one or more parameters associated with communications between the second device and the first device, determining a transmitter circle of a set of multiple transmitter circles for an OAM mode of a set of multiple OAM modes for communications with the second device based on the one or more parameters, and transmitting a message to the second device using the transmitter circle according to the OAM mode based on the determining.

An apparatus for wireless communications at a first device is described. The apparatus may include a processor, memory coupled with the processor, and instructions stored in the memory. The instructions may be executable by the processor to cause the apparatus to receive, from a second device, an indication of one or more parameters associated with communications between the second device and the first device, determine a transmitter circle of a set of multiple transmitter circles for an OAM mode of a set of multiple OAM modes for communications with the second device based on the one or more parameters, and transmit a message to the second device using the transmitter circle according to the OAM mode based on the determining.

Another apparatus for wireless communications at a first device is described. The apparatus may include means for receiving, from a second device, an indication of one or more parameters associated with communications between the second device and the first device, means for determining a transmitter circle of a set of multiple transmitter circles for an OAM mode of a set of multiple OAM modes for communications with the second device based on the one or more parameters, and means for transmitting a message to the second device using the transmitter circle according to the OAM mode based on the determining.

A non-transitory computer-readable medium storing code for wireless communications at a first device is described. The code may include instructions executable by a processor to receive, from a second device, an indication of one or more parameters associated with communications between the second device and the first device, determine a transmitter circle of a set of multiple transmitter circles for an OAM mode of a set of multiple OAM modes for communications with the second device based on the one or more parameters, and transmit a message to the second device using the transmitter circle according to the OAM mode based on the determining.

Some examples of the method, apparatuses, and non-transitory computer-readable medium described herein may further include operations, features, means, or instructions for transmitting a reference signal using a center transmitter circle of the set of multiple transmitter circles, the center transmitter circle being at a center of one or more of the set of multiple transmitter circles, where the transmitter circle may be determined based on the reference signal.

In some examples of the method, apparatuses, and non-transitory computer-readable medium described herein, transmitting the reference signal may include operations, features, means, or instructions for transmitting the reference signal using a set of reference signal resources for the reference signal, where the reference signal, the set of reference signal resources, or both may be unique to the transmitter circle.

Some examples of the method, apparatuses, and non-transitory computer-readable medium described herein may further include operations, features, means, or instructions for transmitting one or more reference signals according to a respective OAM mode of the set of multiple OAM modes via each transmitter circle of the set of multiple transmitter circles, receiving a set of multiple channel gain measurements, each channel gain measurement associated with a respective OAM mode-transmitter circle pairing based on the one or more reference signals, and transmitting one or more messages to the second device using one or more transmitter circles according to a power loading scheme based on the set of multiple channel gain measurements, the power loading scheme associated with one or more OAM modes of the set of multiple OAM modes.

Some examples of the method, apparatuses, and non-transitory computer-readable medium described herein may further include operations, features, means, or instructions for transmitting a first reference signal of a first polarization according to a first OAM mode of the set of multiple OAM modes using the transmitter circle of the set of multiple transmitter circles and transmitting a second reference signal of a second polarization according to the first OAM mode of the set of multiple OAM modes using the transmitter circle of the set of multiple transmitter circles, the second polarization different from the first polarization.

Some examples of the method, apparatuses, and non-transitory computer-readable medium described herein may further include operations, features, means, or instructions for transmitting a first data stream of the first polarization according to the first OAM mode using the transmitter circle and transmitting a second data stream of the second polarization according to the first OAM mode using the transmitter circle.

In some examples of the method, apparatuses, and non-transitory computer-readable medium described herein, the transmitter circle includes a set of multiple antenna sub-arrays, each antenna sub-array including a first antenna element associated with transmissions of the first polarization and a second antenna element associated with transmissions of the second polarization and each of the first and second reference signals may be transmitted using a respective antenna sub-array of the set of multiple antenna sub-arrays.

In some examples of the method, apparatuses, and non-transitory computer-readable medium described herein, the OAM mode may be associated with mode 0 and the transmitter circle includes at least a center transmitter circle of the set of multiple transmitter circles, the center transmitter circle being at a center of one or more of the set of multiple transmitter circles.

Some examples of the method, apparatuses, and non-transitory computer-readable medium described herein may further include operations, features, means, or instructions for transmitting one or more reference signals according to a respective OAM mode of the set of multiple OAM modes via each transmitter circle of the set of multiple transmitter circles.

Some examples of the method, apparatuses, and non-transitory computer-readable medium described herein may further include operations, features, means, or instructions for transmitting an indication of an association between a set of reference signal resources for the one or more reference signals and a respective OAM mode-transmitter circle pairing.

In some examples of the method, apparatuses, and non-transitory computer-readable medium described herein, receiving the indication of one or more parameters may include operations, features, means, or instructions for receiving an indication of a respective transmitter circle for each OAM mode of the set of multiple OAM modes based on the one or more reference signals.

Some examples of the method, apparatuses, and non-transitory computer-readable medium described herein may further include operations, features, means, or instructions for receiving a set of multiple channel gain measurements, each channel gain measurement associated with a respective OAM mode-transmitter circle pairing.

In some examples of the method, apparatuses, and non-transitory computer-readable medium described herein, the transmitter circle of the set of multiple transmitter circles for the OAM mode of the set of multiple OAM modes may be determined based on the indication of the transmitter circle selected for each OAM mode, or the set of multiple channel gain measurements, or both.

In some examples of the method, apparatuses, and non-transitory computer-readable medium described herein, receiving the indication of one or more parameters may include operations, features, means, or instructions for receiving a channel gain measurement associated with each transmitted reference signal.

In some examples of the method, apparatuses, and non-transitory computer-readable medium described herein, receiving the indication of one or more parameters may include operations, features, means, or instructions for receiving a channel gain measurement associated with each mode, where the channel gain measurement may be a highest channel gain measurement associated with the mode.

In some examples of the method, apparatuses, and non-transitory computer-readable medium described herein, receiving the indication of the one or more parameters may include operations, features, means, or instructions for receiving an indication of one or more channel parameters, or one or more receiver device parameters, or both.

In some examples of the method, apparatuses, and non-transitory computer-readable medium described herein, the one or more channel parameters include a path loss measurement between the second device and the first device, or a communication distance between the second device and the first device, or both.

In some examples of the method, apparatuses, and non-transitory computer-readable medium described herein, the one or more receiver device parameters includes a radius of one or more receiver circles of the second device.

Some examples of the method, apparatuses, and non-transitory computer-readable medium described herein may further include operations, features, means, or instructions for calculating a channel gain for each OAM mode-transmitter circle pairing based on the one or more parameters.

In some examples of the method, apparatuses, and non-transitory computer-readable medium described herein, the transmitter circle of the set of multiple transmitter circles for the OAM mode of the set of multiple OAM modes may be determined based on the channel gain calculated for each for a respective OAM mode-transmitter circle pairing.

In some examples of the method, apparatuses, and non-transitory computer-readable medium described herein, receiving the indication of the one or more parameters may include operations, features, means, or instructions for receiving, from the second device, the indication of the one or more parameters via a radio resource control (RRC) message, a medium access control (MAC) control element (CE) message, a downlink control information (DCI) message, an uplink control information (UCI) message, a sidelink control information (SCI) message, or a combination thereof.

Some examples of the method, apparatuses, and non-transitory computer-readable medium described herein may further include operations, features, means, or instructions for transmitting, to the second device, a configuration message indicating the transmitter circle determined for the OAM mode.

A method for wireless communications at a second device is described. The method may include determining one or more parameters associated with communications between the second device and a first device, transmitting, to the first device, an indication of the one or more parameters determined by the second device, and receiving a message from the first device via a transmitter circle of a set of multiple transmitter circles according to an OAM mode of a set of multiple OAM modes.

An apparatus for wireless communications at a second device is described. The apparatus may include a processor, memory coupled with the processor, and instructions stored in the memory. The instructions may be executable by the processor to cause the apparatus to determine one or more parameters associated with communications between the second device and a first device, transmit, to the first device, an indication of the one or more parameters determined by the second device, and receive a message from the first device via a transmitter circle of a set of multiple transmitter circles according to an OAM mode of a set of multiple OAM modes.

Another apparatus for wireless communications at a second device is described. The apparatus may include means for determining one or more parameters associated with communications between the second device and a first device, means for transmitting, to the first device, an indication of the one or more parameters determined by the second device, and means for receiving a message from the first device via a transmitter circle of a set of multiple transmitter circles according to an OAM mode of a set of multiple OAM modes.

A non-transitory computer-readable medium storing code for wireless communications at a second device is described. The code may include instructions executable by a processor to determine one or more parameters associated with communications between the second device and a first device, transmit, to the first device, an indication of the one or more parameters determined by the second device, and receive a message from the first device via a transmitter circle of a set of multiple transmitter circles according to an OAM mode of a set of multiple OAM modes.

Some examples of the method, apparatuses, and non-transitory computer-readable medium described herein may further include operations, features, means, or instructions for receiving a reference signal via a center transmitter circle of the set of multiple transmitter circles, the center transmitter circle being at a center of one or more of the set of multiple transmitter circles, where the one or more parameters may be based on the reference signal.

In some examples of the method, apparatuses, and non-transitory computer-readable medium described herein, receiving the reference signal may include operations, features, means, or instructions for receiving the reference signal using a set of reference signal resources for the reference signal, where the reference signal, the set of reference signal resources, or both may be unique to the transmitter circle.

Some examples of the method, apparatuses, and non-transitory computer-readable medium described herein may further include operations, features, means, or instructions for receiving one or more reference signals according to a respective OAM mode of the set of multiple OAM modes via each transmitter circle of the set of multiple transmitter circles, transmitting a set of multiple channel gain measurements, each channel gain measurement associated with a respective OAM mode-transmitter circle pairing based on the one or more reference signals, and receiving one or more messages from the second device using one or more transmitter circles according to a power loading scheme based on the set of multiple channel gain measurements, the power loading scheme associated with one or more OAM modes of the set of multiple OAM modes.

Some examples of the method, apparatuses, and non-transitory computer-readable medium described herein may further include operations, features, means, or instructions for receiving a first reference signal of a first polarization according to a first OAM mode of the set of multiple OAM modes using the transmitter circle of the set of multiple transmitter circles and receiving a second reference signal of a second polarization according to the first OAM mode of the set of multiple OAM modes using the transmitter circle of the set of multiple transmitter circles, the second polarization different from the first polarization.

Some examples of the method, apparatuses, and non-transitory computer-readable medium described herein may further include operations, features, means, or instructions for receiving a first data stream of the first polarization according to the first OAM mode using the transmitter circle and receiving a second data stream of the second polarization according to the first OAM mode using the transmitter circle.

In some examples of the method, apparatuses, and non-transitory computer-readable medium described herein, the OAM mode may be associated with mode 0 and the transmitter circle includes at least a center transmitter circle of the set of multiple transmitter circles, the center transmitter circle being at a center of one or more of the set of multiple transmitter circles.

Some examples of the method, apparatuses, and non-transitory computer-readable medium described herein may further include operations, features, means, or instructions for receiving one or more reference signals according to a respective OAM mode of the set of multiple OAM modes via each transmitter circle of the set of multiple transmitter circles.

Some examples of the method, apparatuses, and non-transitory computer-readable medium described herein may further include operations, features, means, or instructions for receiving an indication of an association between a set of reference signal resources for the one or more reference signals and a respective OAM mode-transmitter circle pairing.

Some examples of the method, apparatuses, and non-transitory computer-readable medium described herein may further include operations, features, means, or instructions for calculating a channel gain measurement for each reference signal received by the second device, the channel gain measurement associated with an OAM mode-transmitter circle pairing.

Some examples of the method, apparatuses, and non-transitory computer-readable medium described herein may further include operations, features, means, or instructions for selecting a transmitter circle of the set of multiple transmitter circles for each OAM mode of the set of multiple OAM modes based on the channel gain measurement calculated for each reference signal received by the second device.

In some examples of the method, apparatuses, and non-transitory computer-readable medium described herein, transmitting the indication of the one or more parameters may include operations, features, means, or instructions for transmitting an indication of a respective transmitter circle selected for each OAM mode of the set of multiple OAM modes.

In some examples of the method, apparatuses, and non-transitory computer-readable medium described herein, transmitting the indication of the one or more parameters may include operations, features, means, or instructions for transmitting the channel gain measurement associated with each received reference signal.

In some examples of the method, apparatuses, and non-transitory computer-readable medium described herein, transmitting the indication of the one or more parameters may include operations, features, means, or instructions for transmitting the channel gain measurement associated with each mode, where the channel gain measurement may be a highest channel gain measurement associated with the mode.

Some examples of the method, apparatuses, and non-transitory computer-readable medium described herein may further include operations, features, means, or instructions for determining one or more channel parameters, one or more receiver device parameters, or both.

In some examples of the method, apparatuses, and non-transitory computer-readable medium described herein, transmitting the indication of the one or more parameters may include operations, features, means, or instructions for transmitting an indication of the one or more channel parameters, or the one or more receiver device parameters, or both.

In some examples of the method, apparatuses, and non-transitory computer-readable medium described herein, the one or more channel parameters includes a path loss measurement between the second device and the first device, or a communication distance between the second device and the first device, or both, and where the one or more receiver device parameters includes a radius of one or more receiver circles of the second device.

In some examples of the method, apparatuses, and non-transitory computer-readable medium described herein, transmitting the indication of the one or more parameters may include operations, features, means, or instructions for transmitting, to the first device, the indication of the one or more parameters via an RRC message, a MAC-CE message, a DCI message, a UCI message, an SCI message, or a combination thereof.

Some examples of the method, apparatuses, and non-transitory computer-readable medium described herein may further include operations, features, means, or instructions for receiving, from the first device, a configuration message indicating OAM mode-transmitter circle pairings, where the second device receives the message based on the configuration message.

### BRIEF DESCRIPTION OF THE DRAWINGS

FIGS. 1 and 2 illustrate examples of a wireless communications system that supports orbital angular momentum (OAM) transmitter circle selection in accordance with aspects of the present disclosure.

FIG. 3 illustrates an example of a spiral phase plate (SPP) OAM configuration that supports OAM transmitter circle selection in accordance with aspects of the present disclosure.

FIG. 4 illustrates an example of a uniform circular array (UCA) OAM configuration that supports OAM transmitter circle selection in accordance with aspects of the present disclosure.

FIG. 5 illustrates an example of a multi-circle UCA-based OAM configuration that supports OAM transmitter circle selection in accordance with aspects of the present disclosure.

FIGS. 6 and 7 illustrate examples of process flows that support OAM transmitter circle selection in accordance with aspects of the present disclosure.

FIGS. 8 and 9 show block diagrams of devices that support OAM transmitter circle selection in accordance with aspects of the present disclosure.

FIG. 10 shows a block diagram of a communications manager that supports OAM transmitter circle selection in accordance with aspects of the present disclosure.

FIG. 11 shows a diagram of a system including a UE that supports OAM transmitter circle selection in accordance with aspects of the present disclosure.

FIG. 12 shows a diagram of a system including a base station that supports OAM transmitter circle selection in accordance with aspects of the present disclosure.

FIGS. 13 and 14 show block diagrams of devices that support OAM transmitter circle selection in accordance with aspects of the present disclosure.

FIG. 15 shows a block diagram of a communications manager that supports OAM transmitter circle selection in accordance with aspects of the present disclosure.

FIG. 16 shows a diagram of a system including a UE that supports OAM transmitter circle selection in accordance with aspects of the present disclosure.

FIG. 17 shows a diagram of a system including a base station that supports OAM transmitter circle selection in accordance with aspects of the present disclosure.

FIGS. 18 through 23 show flowcharts illustrating methods that support OAM transmitter circle selection in accordance with aspects of the present disclosure.

### DETAILED DESCRIPTION

In some wireless communications systems, wireless devices, such as base stations or user equipments (UEs), or both, may communicate directionally, for example, using beams to orient communication signals over one or more directions. In some systems, such as in orbital angular momentum (OAM)-capable communications systems, the wireless devices may communicate using OAM beams, which, in addition to providing signal directionality, may also provide additional dimensions for signal multiplexing. In some aspects, for example, such additional dimensions may include an OAM state, a polarization, or both, where OAM beams with different OAM states, polarizations, or both may be orthogonal to each other. As such, OAM beams with different OAM states or polarizations may be multiplexed together to increase the capacity of an OAM link. In some cases, a wireless device may use spiral phase plate (SPP) or uniform circular array (UCA)-based methodologies to generate OAM beams.

In some cases, a transmitting device and a receiving device may each be equipped with one or more antenna circles (e.g., UCAs). The one or more antenna circles may include a center antenna circle and one or more peripheral antenna circles that enable the transmitting device and the receiving device to communicate according to one or more OAM modes. In an OAM-based communication system in which a transmitting device, or a receiving device, or both are each equipped with multiple antenna circles, the efficiency of each antenna circle (e.g., channel gains of each antenna circle) may be different for each OAM mode. For example, a signal produced by a first antenna circle according to a first OAM mode may have a different channel gain than a signal produced by a second antenna circle according to the first OAM mode. To increase efficiency and throughput in the OAM-communications system, a transmitting device (e.g., a UE, base station, integrated access and backhaul (IAB) node, relay node) or a receiving device (e.g., a UE, base station, IAB node, relay node), or both may determine a transmission scheme for the transmitting device to use for transmitting messages (e.g., data messages, control messages) to the receiving device. For example, the transmitting device, or the receiving device, or both may be configured to determine which antenna circle of the transmitting device (e.g., transmitter circle) to use for each OAM mode so as to optimize data throughput of each OAM mode.

In some cases, the transmitting device may transmit one or more reference signals according to each OAM mode and using each transmitter circle, resulting in one or more reference signals being transmitted over an OAM mode and transmitter circle pairing (e.g., pair, combination). The receiving device may receive one or more of the reference signals, perform measurements (e.g., channel gain, reference signal received power (RSRP), signal-to-noise ratio (SNR), reference signal received quality (RSRQ)) on each of the received reference signals, and select a transmitter circle (e.g., a preferred transmitter circle) for each OAM mode based on the reference signal measurements. The receiving device may transmit a report to the transmitting device that may indicate the transmitter circle the receiving device selected for each OAM mode. The transmitting device may receive the report and may transmit a message (e.g., a data message, a control message), to the receiving device, according to at least one OAM mode-transmitter circle pairing, such that the transmitting device may transmit a message according to an OAM mode via a transmitter circle associated with that OAM mode, where the pairing may be based on the report. Additionally, or alternatively, the transmitting device may perform a power-sharing procedure between multiple transmitter antenna circles based on channel gain measurements in the report.

In some implementations, a receiving device may determine one or more communication parameters associated with the receiving device, the transmitting device, or both, such as one or more channel parameters (e.g., path loss, communications distance) or one or more receiver parameters (e.g., receiver antenna circle radius). The receiving device may transmit an indication of the one or more parameters to the transmitting device, which the transmitting device may use to select a transmitter circle for each OAM mode (e.g., OAM mode-transmitter circle pairing). In some cases, the transmitting device may perform one or more calculations based on the one or more indicated parameters, such as channel gain measurements, where the transmitting device may select a transmitter circle for each OAM mode based on the one or more measurements. The transmitting device may transmit a message (e.g., a data message, a control message), to the receiving device, according to at least one OAM mode-transmitter circle pairing.

Particular aspects of the subject matter described herein may be implemented to realize one or more advantages. The described techniques may be implemented to realize enhanced communications between devices (e.g., wireless devices) via OAM beams. For example, based on implementing the described OAM mode-transmitter circle pairing techniques, devices may communicate according to an OAM mode via an antenna circle selected for the OAM mode based on the channel gain of the OAM mode-transmitter circle pairing. As such, the OAM mode-transmitter circle pairing techniques as described herein may support improved throughput (e.g., data throughput) in OAM-based communications systems. Further, based on a greater ability to transfer information using OAM-based communications, the wireless devices may experience increased reliability and a greater likelihood of successful communications. As such, supported techniques may include improved network operations and, in some examples, may promote network efficiencies, among other benefits.

Aspects of the disclosure are initially described in the context of wireless communications systems. Aspects are the described with respect to an SPP OAM configuration, a UCA OAM configuration, a multi-circle UCA-based OAM configuration, and process flows. Aspects of the disclosure are further illustrated by and described with reference to apparatus diagrams, system diagrams, and flowcharts that relate to techniques for determining OAM transmitter circles.

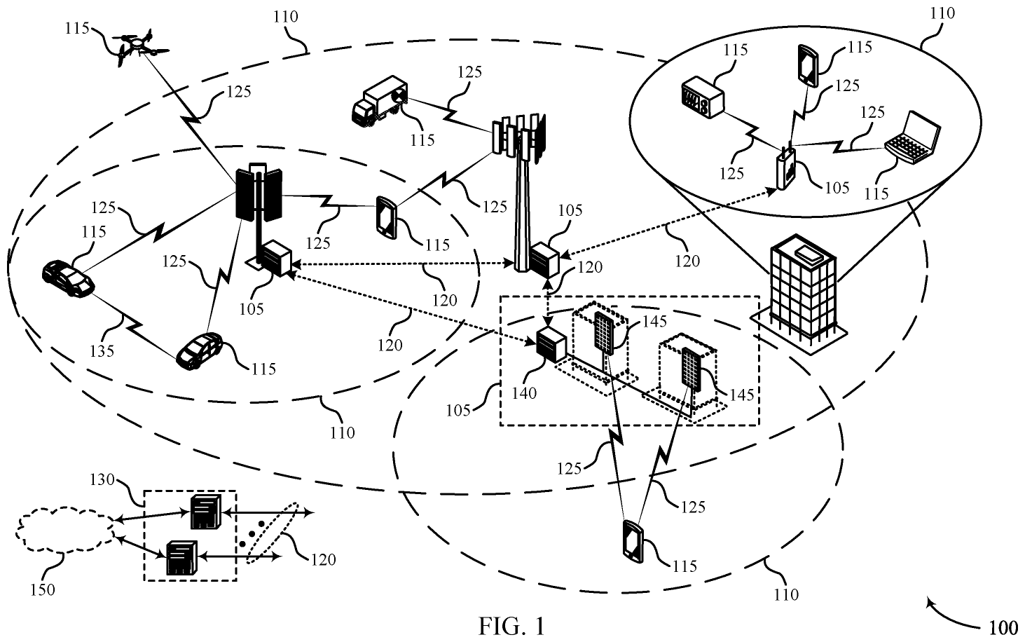

FIG. 1 illustrates an example of a wireless communications system 100 that supports orbital angular momentum transmitter circle selection in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, IAB nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems, such as the wireless communications system 100, a first device, such as a transmitting device, and a second device, such as a receiving device, may each be equipped with one or more antenna circles (e.g., UCAs) that may enable the first device and the second device to communicate according to one or more OAM modes over one or more antenna circles. More specifically, the one or more antenna circles may enable the first device to transmit OAM beams with different OAM states, polarizations, or both to the second device. OAM beams with different OAM states or different polarizations may be orthogonal to each other and, as a result, may be multiplexed on a single channel.

In some aspects, a first device (e.g., a UE 115, base station 105, IAB node, relay node) or a second device (e.g., a UE 115, base station 105, IAB node, relay node), or both may determine a transmission scheme for the first device to use for transmitting messages to the second device. For example, the first device, or the second device, or both may be configured to determine which OAM mode may be transmitted by which antenna circle of the first device (e.g., a transmitter circle). In some cases, the second device may select an antenna circle (e.g., a preferred transmitter antenna circle) for each OAM mode and the second device may transmit a report to the first device that indicates the antenna circle the second device selected for each OAM mode. The first device may transmit a message over at least one OAM mode via at least one antenna circle associated with the at least one OAM mode, in some cases, based on the report from the second device.

Additionally or alternatively, the first device may perform a power-sharing procedure between multiple transmitter antenna circles based on the report such that the first device may transmit different OAM communications over multiple transmitter antenna circles according to different OAM modes. In some cases, a second device may determine one or more communication parameters associated with the second device, the first device, or both such as one or more channel parameters (e.g., path loss, communications distance) or one or more receiver parameters (e.g., receiver antenna circle radius). The second device may transmit an indication of the one or more parameters to the first device, which the first device may use to select one or more antenna circles for one or more OAM modes. The first device may transmit a message over at least one OAM mode via at least one corresponding transmitter circle, selected by the first device.

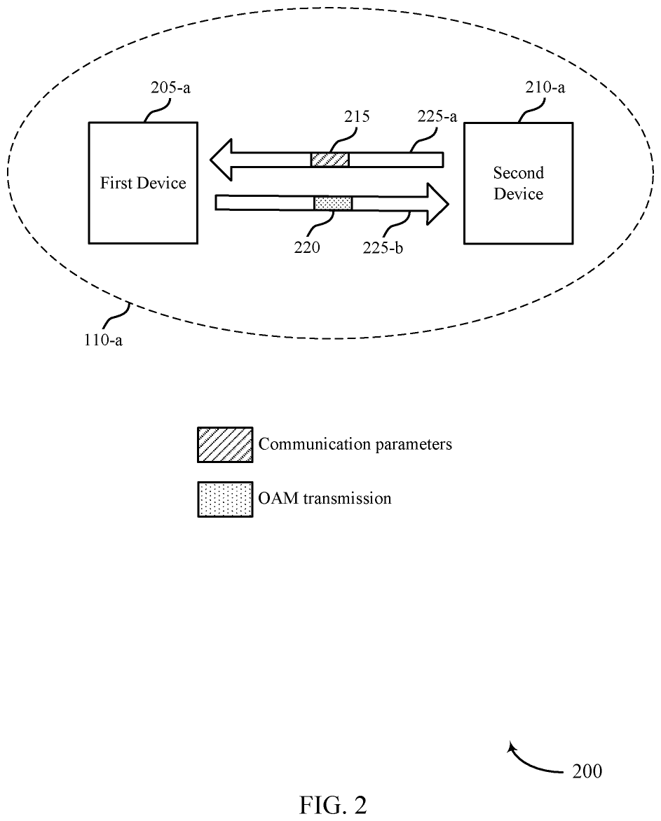

FIG. 2 illustrates an example of a wireless communications system 200 that supports orbital angular momentum transmitter circle selection in accordance with aspects of the present disclosure. In some examples, wireless communications system 200 may implement aspects of wireless communications system 100. The wireless communications system 200 may illustrate communications between a first device 205-a and a second device 210-a, where the first device 205-a and the second device 210-a may be the same device or may be different devices. The first device 205-a and the second device 210-a may each be a UE, a base station, or an IAB node, among other devices. The first device 205-a and the second device 210-a may be examples of corresponding devices described herein. In some cases, the first device 205-a, or the second device 210-a may serve a geographic coverage area 110-a. In some examples, the wireless communications system 200 (which may be an example of a sixth generation (6G) system, a fifth generation (5G) system, or another generation system) may support OAM-based communications and, as such, the first device 205-a and the second device 210-a may transmit or receive OAM beams, or OAM-related signals over communication links 225 within the geographic coverage area 110-a.

In some examples, the first device 205-a or the second device 210-a may support OAM-based communication by using OAM of electromagnetic waves to distinguish between different signals. The OAM of electromagnetic waves may be different than spin angular momentum (SAM) of electromagnetic waves, and both may contribute to the overall angular momentum of an electromagnetic wave as defined in quantum mechanics by Equation 1, shown below.

J=∫∫∫r×s dxdydz=Σ+L (1)

As shown in Equation 1, J is equal to the angular momentum of the electromagnetic wave, r is a position vector, S=E×H and is equal to the Poynting flux, where E is equal to the electric field vector and H is equal to the magnetic field's auxiliary field vector, Σ is equal to the SAM of the electromagnetic wave (and is sometimes alternatively denoted as S), and L is equal to the OAM of the electromagnetic wave. In some cases, the SAM of the electromagnetic wave may be associated with a polarization of the electromagnetic wave. For example, the electromagnetic wave may be associated with different polarizations (e.g., circular polarizations), such as left and right. Accordingly, the SAM of the electromagnetic wave may have multiple (e.g., two) degrees of freedom.

Further, the electromagnetic wave may have two polarizations, either two linear polarizations (e.g., one horizontal and one vertical) or circular and elliptical polarizations (e.g., clockwise and counter-clockwise). Polarization corresponds to SAM as opposed to OAM, and as such SAM and OAM may be two independent properties of an electromagnet wave. The techniques described herein, which support both OAM and polarizations may increase (e.g., double) the number of streams capable of being multiplexed using MIMO.

OAM-based electromagnetic waveforms may be variants of Gaussian beams, as described by the Laguerre-Gaussian modes and waveforms shown below in Equation 2.

$$\\ \begin{matrix}{u}_{l , p} = \sqrt{\frac{2 p !}{π ( p + \vert l \vert ) !}} \frac{1}{w ( z )} {( \frac{p \sqrt{2}}{w ( z )} )}^{\vert l \vert} exp ( \frac{- {p}^{2}}{{w}^{2} ( z )} ) {L}_{p}^{\vert l \vert} ( \frac{2 {p}^{2}}{{w}^{2} ( z )} ) {e}^{il ∅} \times exp ( - ik \frac{{p}^{2} z}{2 ( {z}_{R}^{2} + {z}^{2} )} ) exp [ - i ( 2 p + \vert l \vert + 1 ) {tan}^{- 1} ( \frac{z}{{z}_{R}} ) ] & ( 2 )\end{matrix}$$

The Laguerre-Gaussian modes shown in Equation 2 may include cylindrical polar coordinates (e.g., ρ, φ, and z), where Lₚ^{|l|} is an associated Laguerre polynomial, z R is a Rayleigh range (e.g., a measure of the tightness of the focus) equivalent to the term

$$\\ \frac{{kw}^{2} ( 0 )}{2} , and w ( z ) = w ( 0 ) \sqrt{1 + \frac{{z}^{2}}{{z}_{R}^{2}}}$$

is the beam width. In addition, the azimuth phase term (e.g., e^{ilØ}) may provide a link to OAM based on electromagnetic wave theory and quantum mechanics. In some cases, a situation may arise for a transmitter based on a specific criterion (e.g., z=0). In such cases, the Laguerre-Gaussian modes may be represented by a different equation, shown below in Equation 3.

$$\\ \begin{matrix}{u}_{l , p} ∝ {p}^{\vert l \vert} exp ( - {p}^{2} ) {L}_{p}^{\vert l \vert} ( \frac{2 {p}^{2}}{{w}^{2} ( 0 )} ) {e}^{il φ} & ( 3 )\end{matrix}$$

The OAM waveforms, which may also be referred to as Hermite Gaussian waveforms or Laguerre-Gaussian waveforms, may form a set of complete and orthonormal basis, such that a channel between a transmitter and a receiver may correspond to multiple independent parallel channels, each of which may correspond to a respective OAM waveform indexed by (l,p). In some examples, OAM waveforms may be derived from a combination of Sturm-Liouville theory (in which the polar OAM waveform is assumed to be separable) and a polynomial expansion. OAM waveform derivations may also be derived from information theoretic consequence. According to the information theoretic consequence, a capacity of the channel may be analyzed based on each OAM waveform. In such cases, an optimal transmission scheme may be based on water-filling among the OAM waveforms. Using OAM waveforms as the set of complete and orthonormal basis may align with criteria of an information theoretic analysis.

The derivation of OAM waveforms may be based on using Maxwell equations as vector equations in free space without any free change, which may be solved by a scalar form, namely the Helmholtz equation, shown below in Equation 4.

∇₂v+k₂v=0 (4)

Assuming a paraxial wave (e.g., v=ue^{ikz}) and assuming the variation of amplitude (e.g., u) in the z direction is slow, a term

$$\\ ( e . g . , \frac{{\partial }^{2}}{\partial {z}^{2}} u )$$

may be dropped from the Helmholtz equation shown above in Equation 4. As a result, the Helmholtz equation may become a different equation, shown below in Equation 5.

$$\\ \begin{matrix}i \frac{\partial }{\partial z} u = - \frac{1}{2 k} ( \frac{{\partial }^{2}}{\partial {x}^{2}} + \frac{{\partial }^{2}}{\partial {y}^{2}} ) u & ( 5 )\end{matrix}$$

The partial differential equation shown in Equation 5 may be solved using two approaches, namely a differential solution and an integral solution. More specifically, the integral solution may include the Green function and the Huygens-Fresnel Principle.

Based on the theory of the Green function, which describes a waveform from a single point source with the same boundary condition, the Helmholtz equation shown in Equation 4 may be solved in an integral form, which is the equivalent to the Huygens-Fresnel principle. A signal at a receiver plane v may be written as a function of a transmitter signal u, as shown below in Equation 6.

$$\\ \begin{matrix}v = \int \int u \frac{exp ( jkr )}{r} Ψ dS & ( 6 )\end{matrix}$$

In Equation 6, Ψ may be equivalent to cos θ or some other function of the angle of propagation close to cos θ. In some cases, Ψ may be close to 1 (e.g., Ψ≈1). In some cases, eigen modes may be identified by performing a singular value decomposition (SVD) on a transfer matrix, where a Gaussian term may be present in the eigenvectors.

In some cases, the OAM of the electromagnetic wave may be associated with a field spatial distribution of the electromagnetic wave, which may be in the form of a helical or twisted wavefront shape (e.g., in examples in which a light beam can be associated with a helical or twisted wavefront). For example, an electromagnetic wave (e.g., a light beam) may be in a helical mode (which may also be referred to as an OAM mode) and such helical modes may be characterized by a wavefront that is shaped as a helix with an optical vortex in the center (e.g., at the beam axis), where each helical mode is associated with a different helical wavefront structure. The helical modes (e.g., OAM modes, which may also be referred to as OAM states) may be defined or referred to by a mode index l, where a sign of the mode index l corresponds to a “handedness” (e.g., left or right) of the helix (or helices) and a magnitude of the mode index l (e.g., |l|) corresponds to a quantity of distinct but interleaved helices of the electromagnetic wave.

For example, for an electromagnetic wave associated with an OAM mode index of l=0, the electromagnetic wave is not helical and the wavefronts of the electromagnetic wave are multiple disconnected surfaces (e.g., the electromagnetic wave is a sequence of parallel planes). For an electromagnetic wave associated with an OAM mode index of l=+1, the electromagnetic wave may propagate in a right-handed pattern (e.g., has a right circular polarization or may be understood as having a clockwise circular polarization) and the wavefront of the electromagnetic wave may be shaped as a single helical surface with a step length equal to a wavelength A of the electromagnetic wave. Likewise, the phase delay over one revolution of the electromagnetic wave may be equal to 2π. Similarly, for an OAM mode index of l=−1, the electromagnetic wave may propagate in a left-handed pattern (e.g., has a left circular polarization or may be understood as having a counter-clockwise circular polarization) and the wavefront of the electromagnetic wave may be also be shaped as a single helical surface with a step length equal to the wavelength A of the electromagnetic wave. Likewise, the phase delay over one revolution of the electromagnetic wave may be equal to −2π.

For further example, for an OAM mode index of l=±2, the electromagnetic wave may propagate in either a right-handed pattern (if +2) or in a left-handed pattern (if −2) and the wavefront of the electromagnetic wave may include two distinct but interleaved helical surfaces. In such examples, the step length of each helical surface may be equal to λ/2. Likewise, the phase delay over one revolution of the electromagnetic wave may be equal to +4π. In general terms, a mode-/electromagnetic wave may propagate in either a right-handed pattern or a left-handed pattern (depending on the sign of l) and may include l distinct but interleaved helical surfaces with a step length of each helical surface equal to λ/|l|. Likewise, the phase delay over one revolution of the electromagnetic wave may be equal to 2l π. In some examples, an electromagnetic wave may be indefinitely extended to provide for an infinite number of degrees of freedom of the OAM of the electromagnetic wave (e.g., l=0, ±1, ±2, . . . , ±∞). As such, the OAM of the electromagnetic wave (e.g., L as defined in Equation 1) may be associated with infinite degrees of freedom.

In some examples, the OAM mode index l of an electromagnetic wave may correspond to or otherwise function as (e.g., be defined as) an additional dimension for signal or channel multiplexing. For example, each OAM mode, which may correspond to an OAM state (of which there may be infinite), may function similarly (e.g., or equivalently) to a communication channel, such as a sub-channel. In other words, an OAM mode or state may correspond to a communication channel, and vice versa. For instance, the first device 205-a or the second device 210-a may communicate separate signals using electromagnetic waves having different OAM modes or states similarly to how the first device 205-a or the second device 210-a may transmit separate signals over different communication channels. In some aspects, such use of the OAM modes or states of an electromagnetic wave to carry different signals may be referred to as the use of OAM beams.

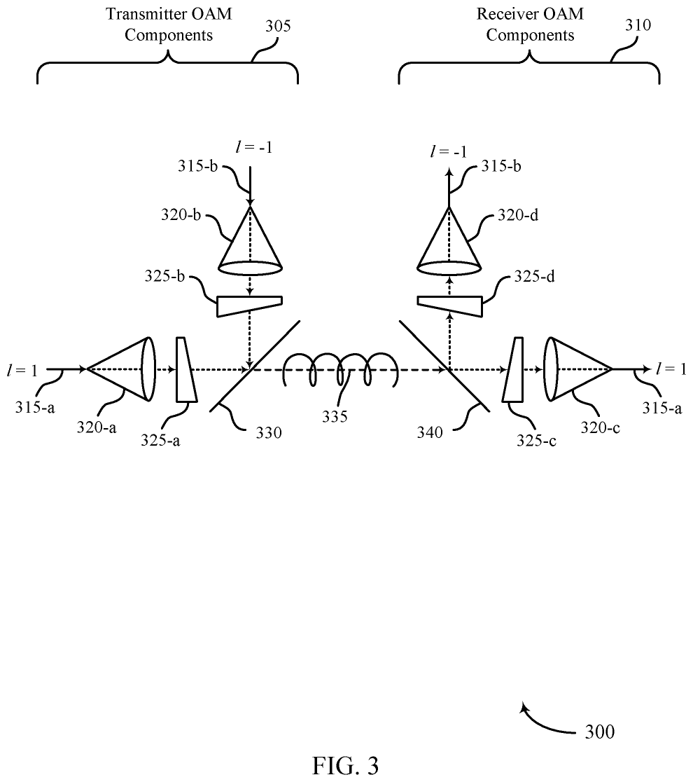

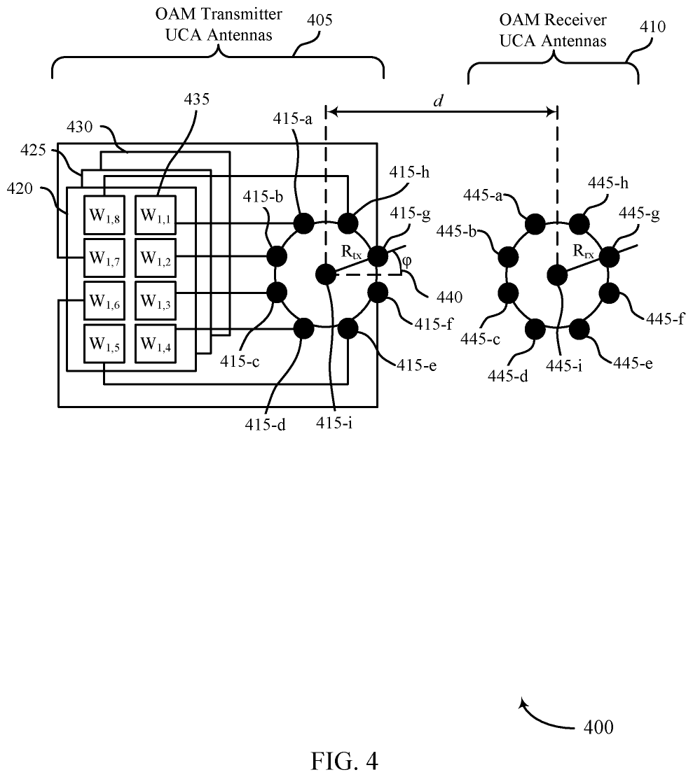

Additionally, in some examples, electromagnetic waves with different OAM modes (e.g., OAM states) may be mutually orthogonal to each other (e.g., in a Hilbert sense, in which a space may include an infinite set of axes and sequences may become infinite by way of always having another coordinate direction in which next elements of the sequence can go). Likewise, in a Hilbert sense, orthogonal OAM modes or states may correspond to orthogonal communication channels (e.g., orthogonal sequences transmitted over a communication channel) and, based on the potentially infinite number of OAM modes or states, the wireless communications system 200 employing the use of OAM beams may theoretically achieve infinite capacity. For example, in theory, an infinite number of OAM states or modes may be twisted together for multiplexing and the capacity of the OAM link can approach infinity while preserving orthogonality between signals carried by different OAM modes (e.g., indices). In practice, however, due to non-ideal factors (e.g., Tx/Rx axial or position placement error, propagation divergence, and the like), crosstalk among OAM modes at the receiver may result, and thus a reduced number of concurrent OAM modes may be implemented between wireless devices (e.g., two or four concurrent OAM modes). In some cases, the first device 205-a or the second device 210-a may generate such OAM beams using SPP or UCA methodologies, as described with reference to FIGS. 3 and 4.

In some aspects, as described with respect to FIG. 4, the first device 205-a, or the second device 210-a, or both may be configured with a set of antennas configured in a circle, such as a UCA antenna circle (e.g., antenna circle, transmitter circle). In some cases, the first device 205-a and the second device 210-a may each be equipped with one or more UCA circles that the first device 205-a and the second device 210-a may use to communicate according to one or more OAM modes. In scenarios in which the first device 205-a, or the second device 210-a, or both each are equipped with multiple UCA circles, the efficiency of each UCA circle (e.g., the channel gain of signals from each UCA circle) may be different for each OAM mode. For example, a signal produced by a first antenna circle according to a first OAM mode may have a different channel gain than a signal produced by a second antenna circle according to the first OAM mode. To increase efficiency and throughput in the OAM-communications system, a transmitting device (e.g., the first device 205-a, the second device 210-a, a UE, base station, IAB node, relay node) or a receiving device (e.g., the first device 205-a, the second device 210-a, a UE, base station, IAB node, relay node), or both may determine a transmission scheme for the transmitting device to use for transmitting messages (e.g., data messages, control messages) to the receiving device. For example, the first device 205-a may be referred to as a transmitting device and the second device 210-a may be referred to as a receiving device, as the first device 205-a may transmit OAM transmissions 220 to the second device 210-a. The first device 205-a, or the second device 210-a, or both may be configured to determine which UCA circle of the first device 205-a to use to transmit according to each OAM mode so as to optimize data throughput of OAM transmissions 220 according to each OAM mode.

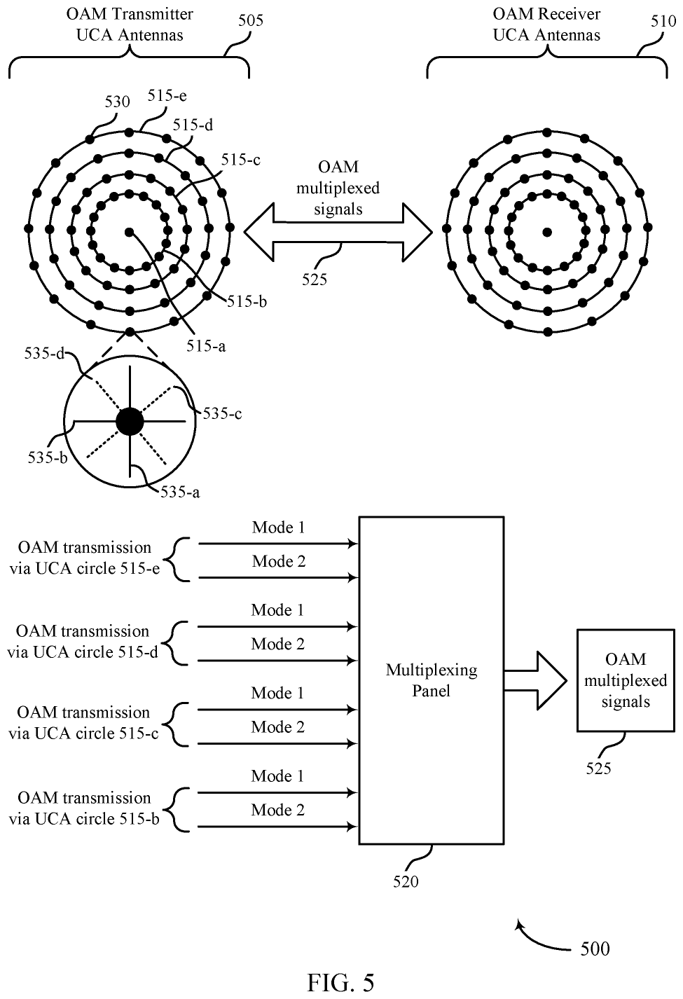

In some cases, the first device 205-a may transmit, to the second device 210-a, one or more reference signals according to each OAM mode and using each UCA circle, resulting in one or more reference signals being transmitted over an OAM mode and UCA circle pairing (e.g., pair, combination). The first device 205-a may transmit the reference signals via communications link 225-b. In some examples, the one or more reference signals may include reference signals that are specific to OAM mode 0, which may be transmitted from a center antenna circle as described with reference to FIG. 5. The second device 210-a may receive one or more of the reference signals, perform measurements (e.g., channel gain, RSRP, SNR, RSRQ) on each of the received reference signals, and select a UCA circle (e.g., a preferred UCA circle) for each OAM mode based on the reference signal measurements. For example, the second device 210-a may identify a UCA circle (e.g., a preferred UCA circle) for each OAM mode based on the identified UCA circle or a set of UCA circles resulting in the highest channel gain for the OAM mode. The second device 210-a may transmit a report to the first device 205-a. For example, the second device 210-a may transmit communication parameters 215 to the first device 205-a via communication link 225-a (e.g., an uplink communications link, a downlink communications link, a sidelink), where the communication parameters 215 may include an indication of the UCA circle the second device 210-a selected for each OAM mode. In some cases, the communication parameters 215 may include channel gain measurements (or other reference signal measurements) associated with the selected OAM mode-UCA circle pairings, or measurements of each received reference signals, or a subset of measurements associated with each OAM mode, such as a number of the highest measurements. The first device may receive the report (e.g., communication parameters 215) and may identify the UCA circles the second device 210-a selected for each OAM mode. The first device 205-a may determine to use the OAM-mode-UCA circle pairings selected by the second device 210-a, or the first device 205-a may select different, or partially different pairings based on measurements performed by the first device 205-a, or based on the measurements received from the second device 210-a, or a combination thereof. In some cases, the first device 205-a may transmit a configuration message to the second device 210-a that indicates the OAM mode-UCA circle pairings the first device 205-a may transmit according to. The first device 205-a may transmit, to the second device 210-a, an OAM transmission (e.g., a data transmission, a control message transmission) via communication link 225-b (e.g., an uplink communications link, a downlink communications link, a sidelink) according to at least one OAM mode via the corresponding UCA circle selected for the OAM mode, where the OAM transmission may be transmitted via the transmission scheme indicated in the configuration message.

In some implementations, to select OAM mode-UCA circle pairings, the second device 210-a may be configured to determine one or more communication parameters 215 associated with the second device 210-a, the first device 205-a, or both, such as one or more channel parameters (e.g., path loss, communications distance) or one or more receiver parameters (e.g., receiver antenna circle radius). The second device 210-a may transmit an indication of the one or more communication parameters 215 to the first device 205-a, which the first device 205-a may use to select a transmitter circle for each OAM mode (e.g., OAM mode-transmitter circle pairing). For example, the first device 205-a may receive the one or more communication parameters 215 and perform one or more calculations based on the one or more communication parameters 215, such as channel gain measurements for each OAM mode and each UCA circle pairing. The first device 205-a may select a UCA circle for each OAM mode based on the one or more measurements. In some cases, the first device 205-a may transmit a configuration message to the second device 210-a that indicates the OAM mode-UCA circle pairings the first device 205-a intends to transmit according to. The first device 205-a may transmit, to the second device 210-a, an OAM transmission (e.g., a data transmission, a control message transmission) via communication link 225-b (e.g., an uplink communications link, a downlink communications link, a sidelink) according to at least one OAM mode via the corresponding UCA circle selected for the OAM mode, where the OAM transmission may be transmitted via the transmission scheme indicated in the configuration message.

Further, although shown as the first device 205-a transmitting an OAM transmission and the second device 210-a transmitting the communication parameters, the first device 205-a or the second device 210-a, or both, may transmit or receive an OAM transmission (e.g., an OAM beam) to or from each other, or other wireless devices, such as peer devices. For example, the first device 205-a may be a base station and the second device 210-a may be a base station, or the first device 205-a may be a UE and the second device 210-a may be a UE. In another example, the first device 205-a may be a base station and the second device may be a UE, or vice versa. Additionally, or alternatively, techniques as discussed herein may be used in communications between UEs, base stations, IAB nodes, relay nodes, access points, other wireless devices, or any combinations thereof.

FIG. 3 illustrates an example of an SPP OAM configuration 300 that supports orbital angular momentum transmitter circle selection in accordance with aspects of the present disclosure. In some examples, the SPP OAM configuration 300 may implement aspects of wireless communications system 100 or 200. In this example, a transmitting device (e.g., UE or base station) may include transmitter OAM components 305 and a receiving device (e.g., UE or base station) may include receiver OAM components 310.

In cases in which the wireless devices use an SPP methodology, the transmitting device may convert an electromagnetic wave 315 associated with an OAM mode index l=0 (e.g., a non-helical electromagnetic wave associated with mode-zero OAM) into an electromagnetic wave associated with an OAM mode index l≠0 (e.g., a helical electromagnetic wave associated with a non-zero OAM mode) based on passing the electromagnetic wave through an aperture 320 (or an array of apertures 320) and an SPP 325. Such an SPP 325 may be associated with geometric constraints and may be able to generate an electromagnetic wave associated with a single OAM mode. Thus, the wireless device may use one SPP 325 to generate an OAM beam 335 associated with one OAM mode. As such, a wireless device may implement a different SPP 325 for each OAM beam 335 that is associated with a different OAM mode.

In the example of FIG. 3, two OAM modes may be used (e.g., 1. =+1 and −1). In the transmitter OAM components, a first electromagnetic wave 315-a may be provided to a first aperture 320-a and a first SPP 325-a, and a second electromagnetic wave 315-b may be provided to a second aperture 320-b and a second SPP 325-b. A beam splitter/combiner 330 may combine the output of the first SPP 325-a and the second SPP 325-b to generate OAM beam 335. The receiver OAM components 310 may receive the OAM beam 335 as a beam splitter/combiner 340 to provide instances of the OAM beam 335 to a third SPP 325-c and a fourth SPP 325-d that provide output to a first receiver aperture 320-c and a second receiver aperture 320-d, respectively. The third SPP 325-c may have geometric constraints corresponding to the first SPP 325-a and thus the output of the first receiver aperture 320-c may correspond to the first electromagnetic wave 315-a (e.g., for OAM Mode=1). Likewise, the fourth SPP 325-d may have geometric constraints corresponding to the second SPP 325-b and thus the output of the second receiver aperture 320-d may correspond to the second electromagnetic wave 315-b (e.g., for OAM Mode 1.=2). In devices that use SPP methodologies, separate SPPs 325-a may thus be used for each OAM mode, and the number of SPPs 325 at a device may constrain the number of usable OAM modes. As discussed, wireless devices may also use a UCA methodology for OAM communications, an example of which is discussed with reference to FIG. 4.

FIG. 4 illustrates an example of a UCA OAM configuration 400 that supports orbital angular momentum transmitter circle selection in accordance with aspects of the present disclosure. In some examples, the UCA OAM configuration 400 may implement aspects of wireless communications systems 100 or 200. In this example, a transmitting device (e.g., a UE or a base station) may include OAM transmitter UCA antennas 405 and a receiving device (e.g., a UE or a base station) may include OAM receiver UCA antennas 410.

In some aspects, one or both of the OAM transmitter UCA antennas 405 or the OAM receiver UCA antennas 410 may be implemented as a planar array of antenna elements which may be an example of or otherwise function as a (massive or holographic) MIMO array or an intelligent surface. In some cases, the transmitting device may identify a set of antenna elements 415 of the planar array that form a transmitter UCA, and a receiving device may identify a set of antenna elements 445 of the planar array that form a receiver UCA.

Upon selecting the set of antenna elements from the planar array, the OAM transmitter may apply a weight 435 to each of the selected antenna elements 415 based on the OAM mode index l of the transmitted OAM beam and one or more spatial parameters associated with each antenna element. In cases in which a UCA methodology is used to generate an OAM beam, the transmitting device may identify the set of antenna elements 415 on a circular array of antenna elements and may apply a first set of weights 420 to each of the identified antenna elements based on a first OAM mode index (e.g., l=0). Further, for other OAM mode indices, other weights may be used for the set of antenna elements 415, such as a second OAM mode index (e.g., l=+1) that may use a second set of weights 425 and a third OAM mode index (e.g., l=−1) that may use a third set of weights 430.

For example, to generate an OAM beam with an OAM mode index (e.g., 1=0), the OAM transmitter may apply a weight 435 to each antenna element 415 on the UCA based on an angle 440 measured between a reference line on the UCA (e.g., the x-axis of the plane on which the UCA is located, where the origin is at the center of the UCA) and the antenna element 415, the OAM mode index l, and i (e.g., for complex-valued weights, which may alternatively be denoted as j in some cases). In some cases, for instance, the weight for an antenna element n may be proportional to e^{i*l*φn}, where φₙ is equal to the angle 440 measured between the reference line on the UCA and the antenna element n. By multiplying respective beamforming weights 435 of each set of weights 420-430 (e.g., for first set of weights 420, w₁=[w_{1,1}, w_{1,2}, . . . , w_{1,8}]^{T}) onto each antenna, a signal port may be generated. If the weight 435 of each antenna element 415 is equal to e^{iφl}, where φ is the angle of antenna 415 in the circle (e.g., angle 440 for antenna element 415-g), and l is the OAM mode index, then each set of weights 420-430 provides a beamformed port that is equivalent to OAM mode l. By using different beamforming weights e^{iφl′}, where l′≠l, multiple OAM modes are thus generated.

In some examples, a transmit antenna element 415-i and a corresponding receive antenna element 445-i may function as a center node within the transmit and receive UCAs. The transmit antenna element 415-i and the receive antenna element 445-i may be associated with OAM mode 0, which may be dynamically configured or hard-coded. In some examples, the transmit antenna element 415-i may be the only transmit antenna element associated with OAM mode 0. In some other examples, both the transmit antenna element 415-i and optionally one or more additional transmit antenna elements (e.g., antenna elements 415-a and 415-d) may be associated with OAM mode 0. Likewise, the receive antenna element 445-i may be the only receive antenna element associated with OAM mode 0, or additional receive antenna elements (e.g., antenna elements 445-a and 445-c) may also be associated with OAM mode 0.

At the OAM receiver UCA antennas 410, the receiving device may have receive antenna elements 445 equipped in a circle. The channel matrix may be denoted from each transmit antenna to each receive antenna as H, and then for the beamformed channel matrix \tilde{H}=H·[w₁,w₂, . . . , w_{L}], any two columns of \tilde{H} may be orthogonal. In some examples, for N transmit antennas and N receive antennas, the transfer matrix H may be found via discreet angular sampling using Equation 7, shown below. In some cases, Equation 7 may omit a cosine factor in an amplitude of the Huygens-Fresnel formula.

$$\\ \begin{matrix}{H}_{m , n} ∝ \frac{exp ( jk \sqrt{{z}^{2} + {( {r}_{1} - {r}_{2} cos {θ}_{2} )}^{2} +} )}{\sqrt{{z}^{2} + {( {r}_{1} cos {θ}_{1} - {r}_{2} cos {θ}_{2} )}^{2} + {( {r}_{1} sin {θ}_{1} - {r}_{2} sin {θ}_{2} )}^{2}}} = \frac{exp \{ jk \sqrt{{z}^{2} + {r}_{1}^{2} + {r}_{2}^{2} - 2 {r}_{1} {r}_{2} cos ( {θ}_{1} - {θ}_{2} )} \}}{\sqrt{{z}^{2} + {r}_{1}^{2} + {r}_{2}^{2} - 2 {r}_{1} {r}_{2} cos ( {θ}_{1} - {θ}_{2} )}} & ( 7 )\end{matrix}$$

In the example of Equation 7, beamformed ports may not experience crosstalk because of orthogonality between columns of the transfer matrix H. This may enable OAM-based communication to realize high-level spatial multiplexing more efficiently. Further, the eigen-based transmit precoding weights and receive combining weights of UCA-based OAM procedures may be equal to a discrete Fourier transform (DFT) matrix. Further, as the transfer matrix H is cyclic, eigenvectors of the transfer matrix H may be DFT vectors, as described in Equation 8.

$$\\ \begin{matrix}{v}_{u} = exp \{ j \frac{2 π μ v}{N} \} & ( 8 )\end{matrix}$$

In the example of Equation 8, μ and v may be integers within a range (e.g., μ=0,1, . . . (N−1), v=0,1, . . . (N−1)), where μ is a vector index of a DFT vector and v is the element index in each DFT vector. With respect to each OAM mode, the μ-th DFT vector may correspond to the μ-th OAM waveform. In some cases, with N transmit antennas and receive antennas, all OAM modes (e.g., 0,1, . . . (N−1)) may be orthogonal at the receiver if any of them are transmitted, regardless of distance z and radii of the transmitter and receiver circles. As a result, per-mode channel estimation and feedback may be used, rather than per-antenna pair feedback. In some cases, it may be beneficial to have both transmitter and receiver planes be co-axial and vertical to the z-axis, although the transmitter and the receiver antennas may have angular offsets, or may be in other configurations.

In some examples, the mode response of each receiver circle may be further analyzed according to Equation 9, which utilizes Taylor expansion approximations.

$$\\ \begin{matrix}\sqrt{{z}^{2} + {r}_{1}^{2} + {r}_{2}^{2} - 2 {r}_{1} {r}_{2} cos ( {θ}_{1} - {θ}_{2} )} = z \sqrt{1 + \frac{{r}_{1}^{2} + {r}_{2}^{2} - 2 {r}_{1} {r}_{2} cos ( {θ}_{1} - {θ}_{2} )}{{z}^{2}}} \approx z ( 1 + \frac{{r}_{1}^{2} + {r}_{2}^{2} - 2 {r}_{1} {r}_{2} cos ( {θ}_{1} - {θ}_{2} )}{2 {z}^{2}} ) = z + \frac{{r}_{1}^{2} + {r}_{2}^{2}}{2 z} - \frac{{r}_{1} {r}_{2} cos ( {θ}_{1} - {θ}_{2} )}{z} & ( 9 )\end{matrix}$$

Equation 9 may then be incorporated into Equation 7, yielding Equation 10 as shown below.

$$\\ \begin{matrix}{H}_{m , n} ∝ \frac{exp \{ jk \sqrt{{z}^{2} + {r}_{1}^{2} + {r}_{2}^{2} - 2 {r}_{1} {r}_{2} cos ( {θ}_{1} - {θ}_{2} )} \}}{\sqrt{{z}^{2} + {r}_{1}^{2} + {r}_{2}^{2} - 2 {r}_{1} {r}_{2} cos ( {θ}_{1} - {θ}_{2} )}} \approx \frac{exp \{ jkz \sqrt{1 + \frac{{r}_{1}^{2} + {r}_{2}^{2} - 2 {r}_{1} {r}_{2} cos ( {θ}_{1} - {θ}_{2} )}{2 {z}^{2}}} \}}{z + \frac{{r}_{1}^{2} + {r}_{2}^{2}}{2 z} - \frac{2 {r}_{1} {r}_{2} cos ( {θ}_{1} - {θ}_{2} )}{z}} \approx \frac{exp \{ jk ( z + \frac{{r}_{1}^{2} + {r}_{2}^{2}}{2 z}}{z} exp \{ \frac{- {jkr}_{1} {r}_{2} cos ( {θ}_{1} - {θ}_{2} )}{z} \} & ( 10 )\end{matrix}$$

Without losing generality, Equation 10 may be simplified into Equation 11 based on setting θ₁ to 0 and ignoring all common terms among receiver antennas.

$$\\ \begin{matrix}{H}_{m , n} ∝ exp \{ \frac{- {jkr}_{1} {r}_{2} cos θ}{z} \} = exp \{ - j 2 π \frac{{r}_{1} {r}_{2}}{λ z} cos θ \} & ( 11 )\end{matrix}$$

In the example of Equation 11, θ may be associated with a range of angular values

$$\\ ( e . g . , θ = 0 , \frac{2 π}{N} , … , \frac{2 ( N - 1 ) π}{N} ) .$$

In Equation 11, analysis of N-DFT vectors of a first term

$$\\ ( e . g . , exp \{ - j 2 π \frac{{r}_{1} {r}_{2}}{λ z} cos θ \} )$$

may be performed within the range of angular values associated with θ₂. If a sub-term

$$\\ ( e . g . , \frac{{r}_{1} {r}_{2}}{λ z} )$$

within the first term of Equation 11 is significantly lower than a threshold (e.g., 1), the critical term may be equivalent to

$$\\ 1 - j 2 π \frac{{r}_{1} {r}_{2}}{λ z} cos θ ,$$

which may be an example of a low-pass filter. Alternatively, if the sub-term is higher than the threshold, the critical term may be highly oscillatory. In some cases, the sub-term may represent a spatial dimension with respect to a wavelength (e.g., λ) of an OAM wave. A response of a specific receiver antenna circle to different OAM modes may depend on geometric sizes and wavelengths corresponding to the receive antenna circle and an OAM wave, respectively.

In some examples, based on Equations 7 through 11, the same DFT matrix is the eigen-matrix, and this does not depend on communication parameters (e.g., distance, aperture size and carrier frequency), and thus UCA-based OAM procedures may be implemented at relatively low cost.

FIG. 5 illustrates an example of a multi-circle UCA-based OAM configuration 500 that supports orbital angular momentum transmitter circle selection in accordance with aspects of the present disclosure. In some examples, the multi-circle UCA-based OAM configuration 500 may implement aspects of wireless communications systems 100 or 200. In this example, a transmitting device (e.g., a UE or a base station) may include OAM transmitter UCA antennas 505 and a receiving device (e.g., a UE or a base station) may include OAM receiver UCA antennas 510.

As described with reference to FIG. 4, the transmitting device and the receiving device may be configured with UCA antennas to realize OAM-based communications. In some implementations, the transmitting device and the receiving device may be configured with multiple UCA antenna circles 515. For example, the transmitting device and the receiving device may each be configured with multiple co-axis UCA antenna circles 515. That is, the transmitting device may be configured with OAM transmitter UCA antennas 505 and the receiving device may be configured with OAM receiver UCA antennas 510. The transmitting device and the receiving device may be configured with the same number of UCA circles 515, or a different number of UCA circles.

In the example depicted by FIG. 5, the transmitting device and the receiving device may each be configured with five antenna circles, where each antenna circle may include one or more antenna elements 530. However, it is to be understood that the transmitting device and the receiving device may each be configured with any number of antenna circles that include any number of antenna elements 530. For example, the transmitting device may be configured with UCA circles 515-a, 515-b 515-c, 515-d, and 515-e, where the number of antenna elements 530 included on each UCA circle 515 may be the same, different, or partially the same. For example, all UCA circles 515 may include the same number of antenna elements 530, or each UCA circle 515 may include a different number of antenna elements 530, or a subset of the UCA circles 515 may include the same number of antenna elements 530. In some cases, the number of antenna elements 530 included on each UCA circle 515 may be based on the radius of the UCA circle 515. Each of the UCA circles 515 that a device is configured with may have the same radius, or different radii, or some may be the same and some may be different. The UCA circles 515 of the transmitting device and the receiving device may be configured in any orientation. For example, the UCA circles 515 may each have a different radius and may be interleaved such that one UCA circle 515 sits inside another UCA circle 515, and so on, as depicted in FIG. 5.

In some examples, each antenna element 530 may be include perpendicular antenna sub-arrays 535. For example, an antenna element 530 may include perpendicular antenna sub-arrays 535-a and 535-b or perpendicular antenna sub-arrays 535-c and 535-c. Although illustrated with two potential perpendicular antenna sub-arrays 535, it is to be understood that the antenna elements 530 may be configured with any number of perpendicular antenna sub-arrays 535 that may be arranged in any orientation or configuration. For example, an antenna element 530 may be equipped with antenna sub-arrays 535 that are perpendicular with respect to an x-axis, a y-axis, or a z-axis, among other examples.

Configuring each antenna element 530 with perpendicular antenna sub-arrays 535 may enable the transmitting device to transmit OAM waveforms with different polarizations. For example, by applying different weights to each antenna sub-array 535, the transmitting device may transmit two OAM waveforms with different polarizations such that the two OAM waveforms are orthogonal to each other. As a result, the transmitting device may transmit the orthogonal OAM waveforms over a single channel without the orthogonal OAM waveforms interfering with each other.

In addition to OAM waveforms with different polarizations being orthogonal to each other, intra-circle OAM transmissions (e.g., OAM signals, OAM streams) may also be orthogonal to each other. That is, OAM transmissions from the same UCA circle 515 may not interfere with one another. As such, OAM transmissions from the same UCA circle 515 that are transmitted according to different OAM states or modes may be multiplexed together to increase the capacity of an OAM link. In some cases, inter-circle OAM transmissions may be orthogonal with different OAM modes, such that OAM transmissions from different UCA circles 515 transmitted according to different OAM modes may be orthogonal to one another. In some cases, inter-circle OAM transmissions may be non-orthogonal with OAM transmissions of the same OAM mode, such that OAM transmissions from different UCA circles 515 transmitted according to the same OAM mode may cause interference (e.g., cross-talk) with another other. For each OAM mode, inter-circle interference may occur when an OAM transmission from one UCA circle 515 mutually interferes with an OAM transmission transmitted from another UCA circle 515, where the two OAM transmissions have the same OAM mode.

As an example, multiple OAM transmissions may be transmitted from each UCA circle 515, where the intra-circle transmissions may be multiplexed if the intra-circle transmissions are associated with different modes. For example, the transmitting device may transmit a first OAM transmission according to OAM mode 1 via UCA circle 515-e and a second OAM transmission according to OAM mode 2 via UCA circle 515-e. Similarly, the transmitting device may transmit a third OAM transmission according to OAM mode 1 via UCA circle 515-d, a fourth OAM transmission according to OAM mode 2 via UCA circle 515-d, a fifth OAM transmission according to OAM mode 1 via UCA circle 515-c, a sixth OAM transmission according to OAM mode 2 via UCA circle 515-c, a seventh OAM transmission according to OAM mode 1 via UCA circle 515-b, and an eighth OAM transmission according to OAM mode 2 via UCA circle 515-b.

In some examples, the transmitting device may transmit one or more OAM transmissions according to OAM mode 0 via UCA circle 515-a. The UCA circle 515-a may be referred to herein as a center, a center circle, a center antenna circle, or a center antenna node and may include a single antenna component or multiple antenna components (e.g., in an antenna array or panel). UCA circle 515-a may be a transmitter configured for the transmitting or receiving device, and may be used for communications according to different modes or polarizations. In some cases, only UCA circle 515-a may transmit OAM transmissions according to OAM mode 0. In some other cases, the center UCA circle 515-a and one or more peripheral UCA circles 515 (e.g., UCA circles 515-e and 515-d) may transmit OAM transmissions according to OAM mode 0. That is, either the center UCA circle 515-a is chosen as the only transmitter or the center and another UCA circle 515 are the transmitters for OAM mode 0.

The center UCA circle 515-a may transmit reference signals that are unique to the center node. That is, the center UCA circle 515-a may transmit reference signals that are specific to OAM mode 0. In addition, the center UCA circle 515-a may have reference signal resources that are reserved for the center UCA circle 515-a. The transmitting device, the receiving device, or both may determine which UCA circles 515 to associate with OAM mode 0 based on the transmitting device using the reserved reference signal resources to transmit one or more reference signals that are unique to the center UCA circle 515-a. In some examples, the one or more reference signals may have different polarizations, such that the receiving device may measure the one or more reference signals and indicate a preferred polarization to the transmitting device.

In some examples, one or more higher OAM modes (e.g., OAM modes other than OAM mode 0) may have a natural null at the center UCA circle 515-a. That is, OAM transmissions that are transmitted from a peripheral UCA circle 515 (e.g., UCA circle 515-e) according to a higher OAM mode may be orthogonal to OAM transmissions transmitted from the center UCA circle 515-a according to OAM mode 0. As a result, the transmitting device may be able to multiplex a first OAM transmission from a peripheral UCA circle 515 with a second OAM transmission from the center UCA circle 515-a.

As described herein, intra-circle OAM transmissions may be orthogonal. As such, the first and second OAM transmissions may be orthogonal to one another, and may, in some cases, be multiplexed. Similarly, the third and fourth transmissions may be orthogonal to one another, the fifth and sixth transmissions may be orthogonal to one another, and the seventh and the eighth transmission may be orthogonal to one another. Further, as described herein, inter-circle OAM transmissions transmitted via different OAM modes may be orthogonal. As such, the first transmission may be orthogonal to the fourth transmission, the sixth transmission, and the eight transmission, for example. Further, as described herein, inter-circle OAM transmissions transmitted via the same OAM mode may be non-orthogonal. As such, the first transmission may be non-orthogonal to the third transmission, the fifth transmission, and the seventh transmission, for example.

In some cases, a transmitting device may transmit the first transmission through the eighth transmission, as described herein, simultaneously. As such, the first transmission through the eighth transmission may pass through a multi-circle UCA panel, such as multiplexing panel 520, that may multiplex one or more of the transmissions into OAM multiplexed signals 525. In some examples, the intra-circle transmissions may be multiplexed. For example, the first transmission and the second transmission may be multiplexed. In another example, the first transmission through the eighth transmission may be multiplexed. The transmitting device may transmit the one or more OAM multiplexed signals 525 to the receiving device, where the OAM receiver UCA antennas 510 of the receiving device may separate the one or more OAM multiplexed signals.

Further, although shown in the example depicted in FIG. 5 as using two OAM modes (a first and a second mode) being transmitted by each UCA circle 515, it is to be understood that each UCA circle 515 may transmit any number of OAM transmissions according to any number of OAM modes. The number of OAM transmissions from each UCA circle 515 may be the same, different, or partially the same, such that all UCA circles 515 at the transmitting device may transmit the same number of transmissions, a different number of transmissions, or some UCA circles 515 may transmit the same number of transmissions while other UCA circles may transmit a different number of transmissions. Further, although the transmitting device and the receiving device are depicted in FIG. 5 as being configured with 5 UCA circles 515, it is to be understood that such devices may be configured with any number of UCA circles 515.

In some cases, as inter-circle OAM transmissions of the same OAM mode may interfere with one another, the transmitting device may be configured to transmit a particular mode via a particular UCA circle 515 so as to mitigate interference caused by inter-cell OAM transmissions of the same mode. The transmitting device, or the receiving device, or both may be configured to determine a transmission scheme for the transmitting device that indicates which UCA circle 515 should be used to transmit which OAM mode. In some implementations, the channel gains of OAM transmission streams may be different from each UCA circle 515 for each OAM mode for a set of parameters. The parameters may include system parameters such as a communication distance between the transmitting device and the receiving device, the radius of each UCA transmitter circle 515, the radius of each UCA receiver circle 515, a carrier frequency, or a number of antenna elements 530 in each UCA circle 515.

For example, for a set of system parameters (in which the parameters are held constant), an OAM mode of 2 or −2 may have a largest channel gain when transmitted via a UCA transmitter circle radius of 0.8 meters. In another example, for the same set of system parameters, an OAM mode of 1 or −1 may have a largest channel gain when transmitted via a UCA transmitter circle radius of 0.6 meters. In another example, for the same set of system parameters, an OAM mode of 0 may have a largest channel gain when transmitted via a UCA transmitter circle radius of 0.2 meters. Therefore, to achieve high data throughput, a transmitting device may be configured to transmit an OAM transmission via an OAM mode-UCA circle pairing that results in the largest channel gain. This low-complexity scheme may increase peak data rates and channel capacity without impairing orthogonality. However, it is to be understood that any number of alternative low-complexity schemes involving OAM transmitter circles with different radii may also be used to improve peak data rates and channel capacity.

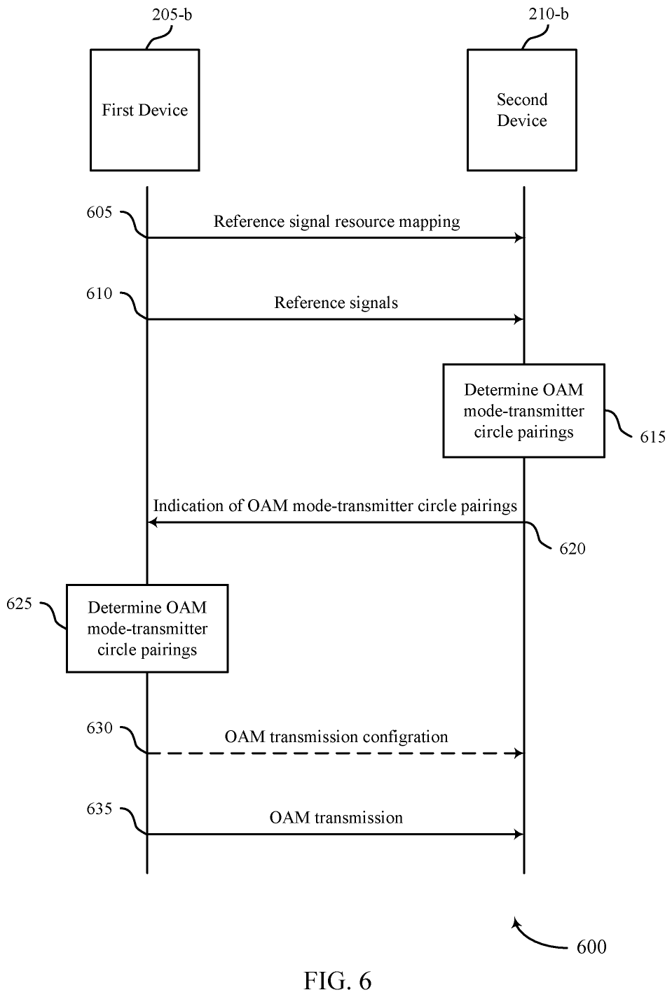

As described with reference to FIGS. 2 and 6, the receiving device may be configured to determine a UCA circle (e.g., an optimal UCA circle 515) for each OAM mode. As described with reference to FIGS. 2, 6, and 7, the transmitting device may be configured to select a UCA circle (e.g., an optimal UCA circle 515) for each OAM mode, resulting in OAM mode-UCA circle pairings.

FIG. 6 illustrates an example of a process flow 600 that supports orbital angular momentum transmitter circle selection in accordance with aspects of the present disclosure. The process flow 600 may illustrate an example OAM-mode-transmitter circle pairing procedure. For example, a first device 205-b (e.g., a transmitting device), or a second device 210-b (e.g., a receiving device), or both may perform techniques to determine a transmitter circle to use for transmitting/receiving according to each OAM mode. The first device 205-b and the second device 210-b may be examples of the corresponding devices (e.g., wireless devices) described with reference to FIGS. 1 through 5, where the first device 205-b and the second device 210-b may be the same device or may be different devices. The first device 205-b and the second device 210-b may each be a UE, a base station, or an IAB node, among other devices. Alternative examples of the following may be implemented, where some steps are performed in a different order than described or are not performed at all. In some cases, steps may include additional features not mentioned below, or further steps may be added.

As described herein, a first device 205-b, or a second device 210-b, or both may be configured to perform an OAM mode-transmitter circle pairing procedure to determine a transmitter circle (e.g., an optimal transmitter circle) to use to transmit an OAM transmission according to each OAM mode to achieve high throughput in an OAM-based communications system (e.g., a co-axial multi-circle OAM-based communications system). In some cases, the second device 210-b may be configured to select a transmitter circle (e.g., a preferred transmitter circle) for each OAM mode, where the selection may be based on reference signal measurements.

At 605, the first device 205-b may transmit, to the second device 210-b, a reference signal resource mapping. The reference signal resource mapping may indicate an association between reference signal resources and an OAM mode-transmitter circle pair. For example, each reference signal resource may be allocated for a particular OAM mode and a particular transmitter circle. The reference signal resource mapping may explicitly indicate which OAM mode and which transmitter circle is associated with each reference signal resource, or the reference signal resource mapping may implicitly indicate which OAM mode and which transmitter circle is associated with each reference signal resource. In some cases, the second device 210-b may be preconfigured with the mapping, or may be pre-configured with one or more mappings, such as in a lookup table. The reference signal resource mapping may indicate an index in a lookup table that indicates which OAM mode and which transmitter circle is associated with each reference signal resource. For example, assume there are N transmitter circles and M OAM modes. In such cases, the reference signal resource mapping may indicate that reference signal resource 1 to reference signal resource N are associated with transmitter circle 1 to transmitter circle N for OAM mode 1. The mapping may indicate that reference signal resource N+1 to reference signal resource 2N are associated with transmitter circle 1 to transmitter circle N for OAM mode 2, and so on such that the mapping may indicate that reference signal resource MN-N+1 to reference signal resource MN are associated with transmitter circle 1 to transmitter circle N for OAM mode M. The first device 205-b may transmit the reference signal resource via RRC layer signaling, a MAC-control element (MAC-CE), physical (PHY)-layer signaling such as downlink control information (DCI), uplink control information (UCI), sidelink control information (SCI), or a combination thereof.

For example, the first device 205-b may be configured with the ability to transmit OAM transmissions according to two OAM modes, a first mode and a second mode, and the first device 205-b may be configured with two transmitter circles, a first transmitter circle and a second OAM transmitter circle. As such, the first device 205-b may transmit four reference signals, each associated with a different reference signal resource (e.g., time and frequency resources). A first reference signal may be associated with the first OAM mode and the first transmitter circle, a second reference signal may be associated with the first OAM mode and the second transmitter circle, a third reference signal may be associated with the second OAM mode and the first transmitter circle, and the fourth reference signal may be associated with the second OAM mode and the second transmitter circle. The first device 205-b may transmit an indication of this reference signal resource mapping to the second device 210-b.

At 610, the first device 205-b may transmit one or more reference signals based on the reference signal resources indicated by the reference signal resource mapping, such that the first device 205-b may transmit a reference signal for each possible OAM mode and transmitter circle pairing. For example, the first device 205-b may transmit the first, second, third, and fourth references signals to the second device 210-b. In some examples, the first device 205-b may transmit the one or more reference signals using different polarizations. For example, the first device 205-b may transmit a first reference signal with a first polarization and a second reference signal with a second polarization from each transmitter circle. The first device 205-b may transmit the first and second reference signals with different polarizations based on applying different weights to antenna elements within antenna sub-arrays of each transmitter circle. Additionally or alternatively, the first device 205-b may transmit one or more reference signals from a center transmitter circle. In some examples, the one or more reference signals transmitted from the center transmitter circle may be unique to the center transmitter circle or an OAM mode associated with the center transmitter circle (e.g., OAM mode 0). The first device 205-b may transmit the one or more reference signals from the center transmitter circle using a set of reference signal resources reserved for the center transmitter circle.

At 615, the second device 210-b may determine OAM mode-transmitter circle pairings. For example, the second device 210-b may receive one or more of the reference signals transmitted by the first device 205-b, and the second device 210-b may measure each of the one or more received reference signals. In some cases, the second device 210-b may measure the channel gain of each of the one or more reference signals. In some cases, the second device 210-b may measure a quality (e.g., RSRP, RSRQ, SINR, SNR) of the one or more reference signals. Based on the measurements, the second device 210-b may determine a transmitter circle (e.g., an optimal transmitter circle) for each OAM mode. For example, the second device 210-b may receive the first, second, third, and fourth reference signals and may measure each of the reference signals. The second device 210-b may determine that, of the first and second reference signals, the first reference signal resulted in the largest channel gain measurement. As such, the second device may select the first transmitter circle for the first OAM mode based on the first reference signal having the largest channel gain measurement. Similarly, the second device 210-b may determine that, of the third and fourth reference signals, the third reference signal resulted in the largest channel gain measurement. As such, the second device may select the first transmitter circle for the second OAM mode based on the third reference signal having the largest channel gain measurement. As such, the second device 210-b may select the first transmitter circle for the first OAM mode and the second OAM mode.

At 620, the second device 210-b may transmit, to the first device 205-b, an indication of the OAM mode-transmitter circle pairings. For example, the second device 210-b may transmit a message indicating that the second device 210-b selected the second transmitter circle for the first OAM mode and the first transmitter circle for the second OAM mode. In some cases, the indication may include an index of the one or more selected transmitter circles and an association between each index and the corresponding OAM mode or reference signal. In some cases, the indication may include one or more reference signal measurements (e.g., channel gain measurements). As an example, the second device 210-b may determine one or more channel gain measurements based on measuring the one or more reference signals. Each of the one or more channel gain measurements may correspond to a specific OAM mode. Additionally or alternatively, each of the one or more channel gain measurements may be associated with a specific transmitter circle, a specific receiver circle, or both. In such cases, the one or more channel gain measurements may be used to apply power loading across different OAM modes. For example, the first device 205-b may apply a first power to a first transmitter circle associated with a first OAM mode based on a channel gain measurement corresponding to the first transmitter circle, and may apply a second power to a second transmitter circle associated with a second OAM mode based on a channel gain measurement corresponding to the second transmitter circle.

In some aspects, the second device 210-b may be configured to include each of the reference signal measurements (e.g., all of the reference signal measurements) performed by the second device 210-b. In some aspects, the second device 210-b may be configured to include a top number (e.g., x) of the reference signal measurements for each OAM mode (e.g., that indicate the top x transmitter circles for each OAM mode). In some aspects, the second device 210-b may transmit the reference signal measurements for the indicated OAM mode-transmitter circle pairings selected by the second device 210-b. For example, the second device 210-b may include the reference signal measurements for the first reference signal and the third reference signal. In some aspects, the second device 210-b may transmit the indication of the OAM mode-transmitter circle pairings via an RRC layer signaling, a MAC-CE, or via PHY-layer signaling such as DCI, UCI, or SCI messages. In some cases, the OAM mode-transmitter circle pairings, the reference signal measurements, or both may be referred to as parameters. As such, at 620, the second device 210-b may transmit an indication of one or more parameters associated with communications between the second device 210-b and the first device 205-b.

In some report formats, the indication may express each transmitter circle index by [log₂N] bits, where the indication may include M*┌log₂N┐ bits. In some scenarios, due to transmitter hardware restrictions, software restrictions, or both, each transmitter circle may transmit one OAM mode (e.g., only one OAM mode). In this case, the indicated transmitter circle indexes for each OAM mode are different, and thus M≤N. To mitigate signaling overhead, another report format may express the queue of transmitter circle indexes by ┌log₂P_{N}^{M}┐ bits, where

$$\\ {P}_{N}^{M} = N ( N - 1 ) … ( N - M + 1 ) = \frac{N !}{( N - M ) !} ,$$

and N! may refer to the factorial function (e.g., the product of all the integers from 1 to N, where ┌log₂P_{N}^{M}┐≤M*┌log₂N┐). Both report formats described herein may be utilized for different configurations of OAM mode 0. For example, both report formats may be used when a center node is chosen as the only transmitter for OAM mode 0, or when the center node and another center transmitter circle are chosen as transmitters for OAM mode 0.

At 625, the first device 205-b may determine OAM mode-transmitter circle pairings. For example, the first device 205-b may determine a transmitter circle of a set of transmitter circles for an OAM mode of a set of OAM modes for communications with the second device 210-b based on the parameters received from the second device 210-b. The first device 205-b may receive an indication of the reference signal pairings, reference signal measurements, or both and the first device 205-b may determine to use the pairings determined by the second device 210-b, or the first device 205-b may select different pairings.

In some cases, at 630, the first device 205-b may transmit, to the second device 210-b, an OAM transmission configuration. The first device 205-b may be configured to transmit the OAM transmission configuration periodically, semi-statically, or aperiodically. The first device 205-b may be configured to transmit the OAM transmission configuration before each OAM transmission. Additionally or alternatively, the first device 205-b may be configured to transmit the OAM transmission configuration when OAM mode-transmitter circle pairings selected by the first device 205-b differ from those selected by the second device 210-b. If, for example, the first device 205-b determines to use the OAM mode-transmitter circle pairings selected by the second device 210-b, then the first device 205-b may be configured to refrain from transmitting an OAM transmission configuration.

At 635, the first device 205-b may transmit, to the second device 210-b, one or more OAM transmissions (e.g., OAM-based data transmissions, control message transmissions), where the OAM transmissions are transmitted according to the OAM mode-transmitter circle pairings determined by the first device 205-b, the second device 210-b, or both. As OAM mode-transmitter circles pairings may be selected based on channel gain (e.g., highest channel gain, optimal channel gain), the one or more OAM transmissions may achieve improved throughput (e.g., data throughput). Additionally or alternatively, the first device 205-b may transmit the one or more OAM transmissions using a power loading procedure based on channel gain measurements. For example, the first device 205-b may transmit a first OAM transmission to the second device 210-b on a first transmitter circle using a first power level, and may transmit a second OAM transmission to the second device 210-b on a second transmitter circle using a second power level.

In some examples, the first device 205-b may transmit the one or more OAM transmissions (e.g., data streams) to the second device 210-b using different polarizations. For example, the first device 205-b may transmit a first OAM transmission and a second OAM transmission to the second device 210-b, where the first OAM transmission is associated with a first polarization and the second OAM transmission is associated with a second polarization that is different from the first polarization. Additionally or alternatively, the first device 205-b may transmit one or more OAM transmissions using OAM mode 0. For example, the first device 205-b may transmit an OAM transmission from a center transmitter circle, a peripheral transmitter circle, or both using OAM mode 0.

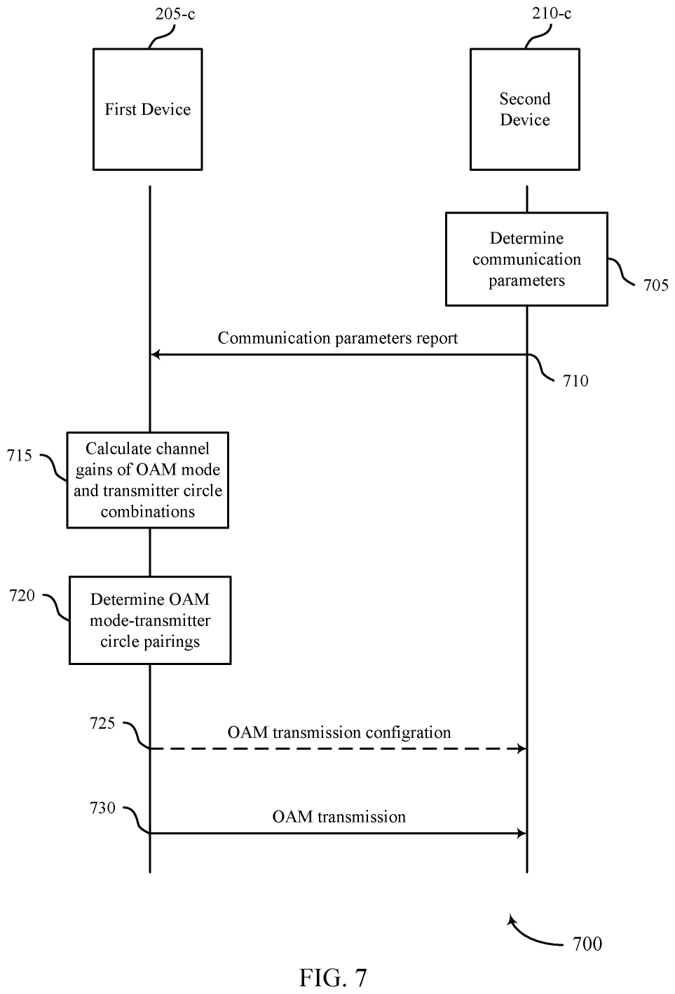

FIG. 7 illustrates an example of a process flow 700 that supports orbital angular momentum transmitter circle selection in accordance with aspects of the present disclosure. The process flow 700 may illustrate an example OAM-mode-transmitter circle pairing procedure. For example, a first device 205-c (e.g., a transmitting device), or a second device 210-c (e.g., a receiving device), or both may perform techniques to determine a transmitter circle to use for transmitting/receiving according to each OAM mode. The first device 205-c and the second device 210-c may be examples of the corresponding devices (e.g., wireless devices) described with reference to FIGS. 1 through 6, where the first device 205-c and the second device 210-c may be the same device or may be different devices. The first device 205-c and the second device 210-c may each be a UE, a base station, or an IAB node, among other devices. Alternative examples of the following may be implemented, where some steps are performed in a different order than described or are not performed at all. In some cases, steps may include additional features not mentioned below, or further steps may be added.

As described herein, a first device 205-c, or a second device 210-c, or both may be configured to perform an OAM mode-transmitter circle pairing procedure to determine which transmitter circle (e.g., optimal transmitter circle) to use for each OAM mode to achieve high throughput in an OAM-based communications system (e.g., a co-axial multi-circle OAM-based communications system). In some cases, the second device 210-b may determine one or more communication parameters that the first device 205-c may use to select a transmitter circle (e.g., a preferred transmitter circle) for each OAM mode.

At 705, the second device 210-c may determine one or more communication parameters associated with communications between the first device 205-c and the second device 210-c. The one or more communication parameters may be associated with the first device 205-c, the second device 210-c, or a combination thereof. The communication parameters may include one or more channel parameters, one or more receiver parameters, or both. The one or more channel parameters may include a path loss measurement, or a communication distance, or both. For example, the second device 210-c may measure the path loss between the first device 205-c (e.g., the OAM transmitter) and the second device 210-c. The second device 210-c may measure the communication distance between the first device 205-c (e.g., the OAM transmitter) and the second device 210-c. In some aspects, the communication parameters may include one or more receiver device parameters such as a radius of one or more receiver circles of the second device 210-c.

At 710, the second device 210-c may transmit, to the first device 205-c, a report including an indication of the one or more communication parameters. For example, the first device 205-c may transmit an indication of one or more parameters associated with communications between the second device 210-c and the first device 205-c. The report may indicate one or more channel parameters (e.g., such as pathloss, and/or communication distance) and/or one or more receiver parameters (such as a number of receiver antenna circles and radii of such receiver antenna circles) to the transmitter. In some implementations, the second device 210-c may transmit the report via RRC signaling, a MAC-CE, or PHY-layer signaling such as a DCI message, a UCI message, or an SCI message.

At 715, the first device 205-c may calculate channel gain (or some other channel quality parameter) of OAM mode and transmitter circle combinations. The first device 205-c may calculate the channel gain of each OAM mode based on path loss, communication distance, receiver parameters, transmitter parameters, or a combination thereof.

In some aspects, the first device 205-c (e.g., the OAM transmitter) may calculate the channel response strength of an OAM mode at a particular radius of the second device 210-c (e.g., the OAM receiver), based on system parameters (e.g., communication distance z, transmitter aperture radius rₜₓ, receiver aperture radius rᵣₓ, wave-length λ), and preconfigured formulas (e.g., theoretical formulas). For example, for UCA-based OAM communication, the channel response strength \tilde{h}_{n,l}_{ᵢ} of an OAM mode lᵢ, at receiver antenna circle n by be calculation according to Equation 12.

$$\\ \begin{matrix}{\tilde{h}}_{n , {l}_{i}} = {\sum }_{m = 0}^{M - 1} {h}_{n , m} \cdot {e}^{{jl}_{i} {θ}_{m}} = \frac{\sqrt{G} λ}{4 π} {\sum }_{m = 0}^{M - 1} \frac{1}{{d}_{m , n}} exp ( {jl}_{i} {θ}_{m} - j 2 π ) \frac{{d}_{m , n}}{λ} & ( 12 )\end{matrix}$$

In Equation 12, d_{m,n}=\sqrt{rₜₓ²+rᵣₓ²+z²−2rₜₓrᵣₓ cos(θₘ−θₙ)}, and θₘ and θₙ are the angles of the transmitter antenna and the receiver antenna, respectively. Based on Equation 12, the first device 205 may determine which transmitter circle (e.g., which transmitter aperture radius) is associated with the highest channel gain for each OAM mode.

At 720, the first device 205-c may determine OAM mode-transmitter circle pairings based on the calculations. For example, the first device 205-c may determine a transmitter circle of a set of transmitter circles for an OAM mode of a set of OAM modes for communications with the second device 210-c based on the one or more parameters.

In some cases, at 725, the first device 205-c may transmit, to the second device 210-c, an OAM transmission configuration. The first device 205-c may be configured to transmit the OAM transmission configuration periodically, semi-statically, or aperiodically. The first device 205-c may be configured to transmit the OAM transmission configuration before each OAM transmission. Additionally or alternatively, the first device 205-c may be configured to transmit the OAM transmission configuration in the case that the OAM transmission configuration changed relative to a previous OAM transmission configuration. In some examples, the OAM transmission configuration may include an indication of a power loading scheme, as described with reference to FIG. 6.

At 730, the first device 205-c may transmit, to the second device 210-c, one or more OAM transmissions (e.g., OAM-based data transmissions, control message transmissions), where the OAM transmissions are transmitted according to the OAM mode-transmitter circle pairings determined by the first device 205-c. As OAM mode-transmitter circles pairings may be selected based on channel gain (e.g., highest channel gain, optimal channel gain), the one or more OAM transmissions may achieve improved throughput (e.g., data throughput). In some examples, the first device 205-c may transmit the one or more OAM transmissions to the second device 210-c using different polarizations. Additionally or alternatively, the first device 205-c may transmit the one or more OAM transmissions to the second device 210-c using different power levels in accordance with a power loading scheme. In some examples, the first device 205-c may transmit the one or more OAM transmissions to the second device 210-c via a center transmitter circle, a peripheral transmitter circle, or both using OAM mode 0.

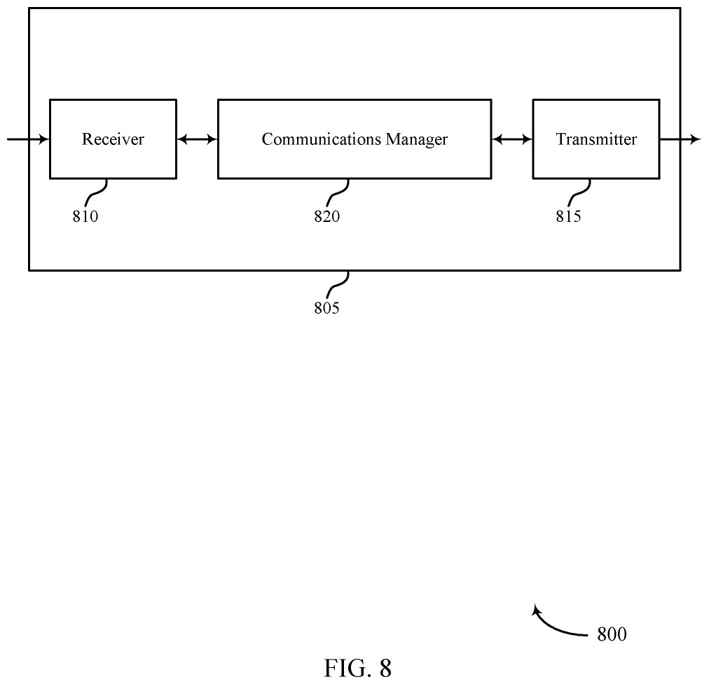

FIG. 8 shows a block diagram 800 of a device 805 that supports orbital angular momentum transmitter circle selection in accordance with aspects of the present disclosure. The device 805 may be an example of aspects of a UE 115 or a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to orbital angular momentum transmitter circle selection). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to orbital angular momentum transmitter circle selection). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of orbital angular momentum transmitter circle selection as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a first device in accordance with examples as disclosed herein. For example, the communications manager 820 may be configured as or otherwise support a means for receiving, from a second device, an indication of one or more parameters associated with communications between the second device and the first device. The communications manager 820 may be configured as or otherwise support a means for determining a transmitter circle of a set of multiple transmitter circles for an orbital angular momentum mode of a set of multiple orbital angular momentum modes for communications with the second device based on the one or more parameters. The communications manager 820 may be configured as or otherwise support a means for transmitting a message to the second device using the transmitter circle according to the orbital angular momentum mode based on the determining.

Additionally or alternatively, the communications manager 820 may support wireless communications at a second device in accordance with examples as disclosed herein. For example, the communications manager 820 may be configured as or otherwise support a means for determining one or more parameters associated with communications between the second device and a first device. The communications manager 820 may be configured as or otherwise support a means for transmitting, to the first device, an indication of the one or more parameters determined by the second device. The communications manager 820 may be configured as or otherwise support a means for receiving a message from the first device via a transmitter circle of a set of multiple transmitter circles according to an orbital angular momentum mode of a set of multiple orbital angular momentum modes.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for more efficient utilization of communication resources based on using one or more UCAs to multiplex OAM transmissions with different OAM states, polarizations, or both.

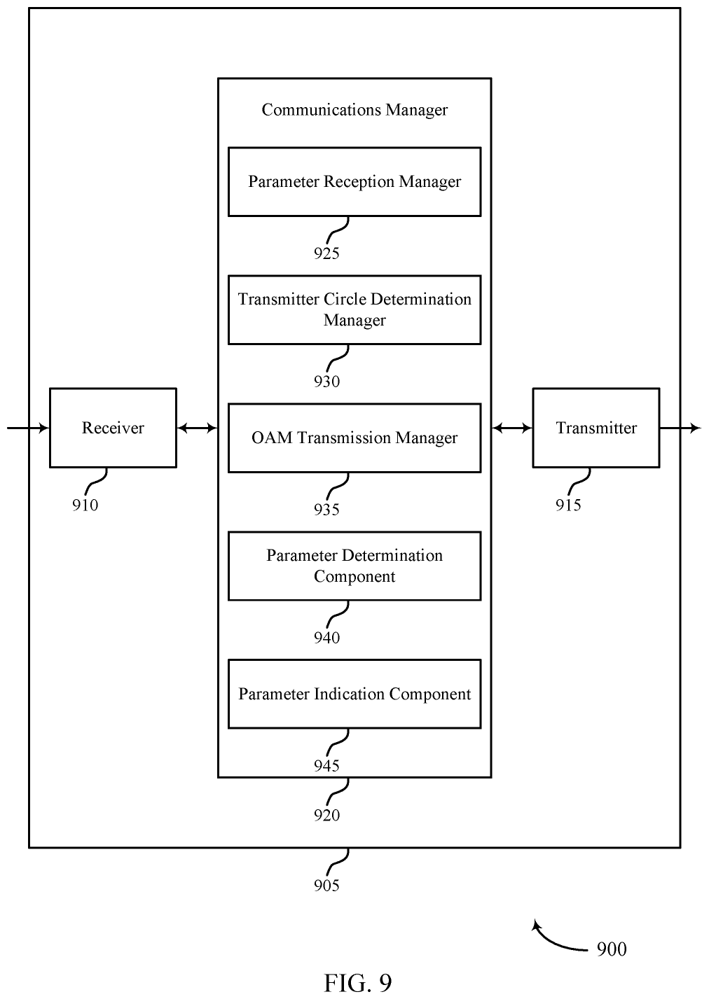

FIG. 9 shows a block diagram 900 of a device 905 that supports orbital angular momentum transmitter circle selection in accordance with aspects of the present disclosure. The device 905 may be an example of aspects of a device 805, a UE 115, or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to orbital angular momentum transmitter circle selection). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to orbital angular momentum transmitter circle selection). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of orbital angular momentum transmitter circle selection as described herein. For example, the communications manager 920 may include a parameter reception manager 925, a transmitter circle determination manager 930, a OAM transmission manager 935, a parameter determination component 940, a parameter indication component 945, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a first device in accordance with examples as disclosed herein. The parameter reception manager 925 may be configured as or otherwise support a means for receiving, from a second device, an indication of one or more parameters associated with communications between the second device and the first device. The transmitter circle determination manager 930 may be configured as or otherwise support a means for determining a transmitter circle of a set of multiple transmitter circles for an orbital angular momentum mode of a set of multiple orbital angular momentum modes for communications with the second device based on the one or more parameters. The OAM transmission manager 935 may be configured as or otherwise support a means for transmitting a message to the second device using the transmitter circle according to the orbital angular momentum mode based on the determining.

Additionally or alternatively, the communications manager 920 may support wireless communications at a second device in accordance with examples as disclosed herein. The parameter determination component 940 may be configured as or otherwise support a means for determining one or more parameters associated with communications between the second device and a first device. The parameter indication component 945 may be configured as or otherwise support a means for transmitting, to the first device, an indication of the one or more parameters determined by the second device. The OAM transmission manager 935 may be configured as or otherwise support a means for receiving a message from the first device via a transmitter circle of a set of multiple transmitter circles according to an orbital angular momentum mode of a set of multiple orbital angular momentum modes.

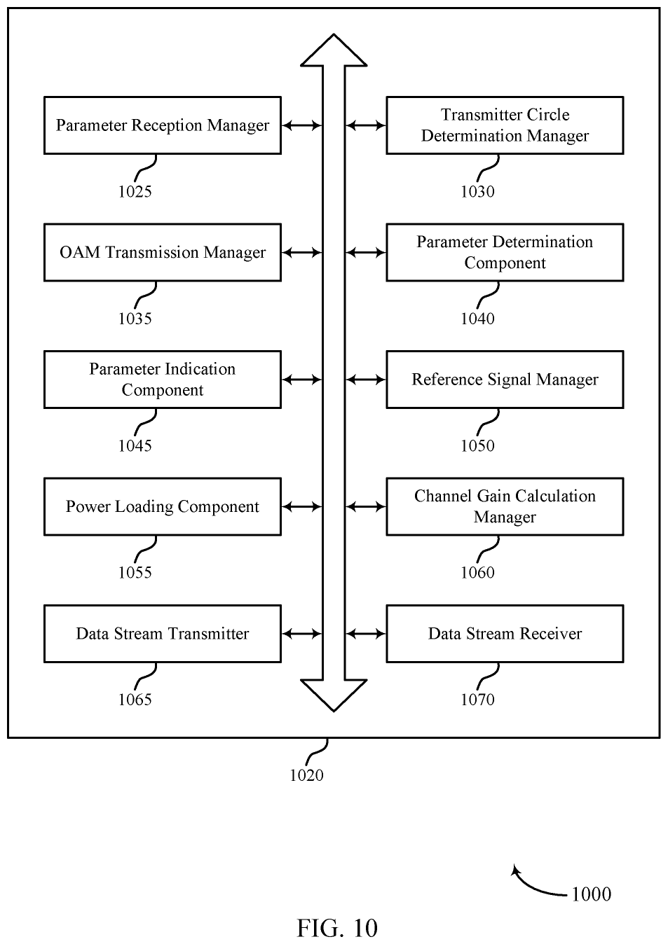

FIG. 10 shows a block diagram 1000 of a communications manager 1020 that supports orbital angular momentum transmitter circle selection in accordance with aspects of the present disclosure. The communications manager 1020 may be an example of aspects of a communications manager 820, a communications manager 920, or both, as described herein. The communications manager 1020, or various components thereof, may be an example of means for performing various aspects of orbital angular momentum transmitter circle selection as described herein. For example, the communications manager 1020 may include a parameter reception manager 1025, a transmitter circle determination manager 1030, a OAM transmission manager 1035, a parameter determination component 1040, a parameter indication component 1045, a reference signal manager 1050, a power loading component 1055, a channel gain calculation manager 1060, a data stream transmitter 1065, a data stream receiver 1070, or any combination thereof. Each of these components may communicate, directly or indirectly, with one another (e.g., via one or more buses).

The communications manager 1020 may support wireless communications at a first device in accordance with examples as disclosed herein. The parameter reception manager 1025 may be configured as or otherwise support a means for receiving, from a second device, an indication of one or more parameters associated with communications between the second device and the first device. The transmitter circle determination manager 1030 may be configured as or otherwise support a means for determining a transmitter circle of a set of multiple transmitter circles for an orbital angular momentum mode of a set of multiple orbital angular momentum modes for communications with the second device based on the one or more parameters. The OAM transmission manager 1035 may be configured as or otherwise support a means for transmitting a message to the second device using the transmitter circle according to the orbital angular momentum mode based on the determining.

In some examples, the reference signal manager 1050 may be configured as or otherwise support a means for transmitting a reference signal using a center transmitter circle of the set of multiple transmitter circles, the center transmitter circle being at a center of one or more of the set of multiple transmitter circles, where the transmitter circle is determined based on the reference signal.

In some examples, to support transmitting the reference signal, the reference signal manager 1050 may be configured as or otherwise support a means for transmitting the reference signal using a set of reference signal resources for the reference signal, where the reference signal, the set of reference signal resources, or both are unique to the transmitter circle.

In some examples, the reference signal manager 1050 may be configured as or otherwise support a means for transmitting one or more reference signals according to a respective orbital angular momentum mode of the set of multiple orbital angular momentum modes via each transmitter circle of the set of multiple transmitter circles. In some examples, the parameter reception manager 1025 may be configured as or otherwise support a means for receiving a set of multiple channel gain measurements, each channel gain measurement associated with a respective orbital angular momentum mode-transmitter circle pairing based on the one or more reference signals. In some examples, the power loading component 1055 may be configured as or otherwise support a means for transmitting one or more messages to the second device using one or more transmitter circles according to a power loading scheme based on the set of multiple channel gain measurements, the power loading scheme associated with one or more orbital angular momentum modes of the set of multiple orbital angular momentum modes.

In some examples, the reference signal manager 1050 may be configured as or otherwise support a means for transmitting a first reference signal of a first polarization according to a first orbital angular momentum mode of the set of multiple orbital angular momentum modes using the transmitter circle of the set of multiple transmitter circles. In some examples, the reference signal manager 1050 may be configured as or otherwise support a means for transmitting a second reference signal of a second polarization according to the first orbital angular momentum mode of the set of multiple orbital angular momentum modes using the transmitter circle of the set of multiple transmitter circles, the second polarization different from the first polarization.

In some examples, the data stream transmitter 1065 may be configured as or otherwise support a means for transmitting a first data stream of the first polarization according to the first orbital angular momentum mode using the transmitter circle. In some examples, the data stream transmitter 1065 may be configured as or otherwise support a means for transmitting a second data stream of the second polarization according to the first orbital angular momentum mode using the transmitter circle.

In some examples, the transmitter circle includes a set of multiple antenna sub-arrays, each antenna sub-array including a first antenna element associated with transmissions of the first polarization and a second antenna element associated with transmissions of the second polarization. In some examples, each of the first and second reference signals is transmitted using a respective antenna sub-array of the set of multiple antenna sub-arrays.

In some examples, the orbital angular momentum mode is associated with mode 0. In some examples, the transmitter circle includes at least a center transmitter circle of the set of multiple transmitter circles, the center transmitter circle being at a center of one or more of the set of multiple transmitter circles.

In some examples, the reference signal manager 1050 may be configured as or otherwise support a means for transmitting one or more reference signals according to a respective orbital angular momentum mode of the set of multiple orbital angular momentum modes via each transmitter circle of the set of multiple transmitter circles.

In some examples, the reference signal manager 1050 may be configured as or otherwise support a means for transmitting an indication of an association between a set of reference signal resources for the one or more reference signals and a respective orbital angular momentum mode-transmitter circle pairing.

In some examples, to support receiving the indication of one or more parameters, the parameter reception manager 1025 may be configured as or otherwise support a means for receiving an indication of a respective transmitter circle for each orbital angular momentum mode of the set of multiple orbital angular momentum modes based on the one or more reference signals.

In some examples, the parameter reception manager 1025 may be configured as or otherwise support a means for receiving a set of multiple channel gain measurements, each channel gain measurement associated with a respective orbital angular momentum mode-transmitter circle pairing.

In some examples, the transmitter circle of the set of multiple transmitter circles for the orbital angular momentum mode of the set of multiple orbital angular momentum modes is determined based on the indication of the transmitter circle selected for each orbital angular momentum mode, or the set of multiple channel gain measurements, or both.

In some examples, to support receiving the indication of one or more parameters, the parameter reception manager 1025 may be configured as or otherwise support a means for receiving a channel gain measurement associated with each transmitted reference signal.

In some examples, to support receiving the indication of one or more parameters, the parameter reception manager 1025 may be configured as or otherwise support a means for receiving a channel gain measurement associated with each mode, where the channel gain measurement is a highest channel gain measurement associated with the mode.

In some examples, to support receiving the indication of the one or more parameters, the parameter reception manager 1025 may be configured as or otherwise support a means for receiving an indication of one or more channel parameters, or one or more receiver device parameters, or both.

In some examples, the one or more channel parameters include a path loss measurement between the second device and the first device, or a communication distance between the second device and the first device, or both.

In some examples, the one or more receiver device parameters includes a radius of one or more receiver circles of the second device.

In some examples, the channel gain calculation manager 1060 may be configured as or otherwise support a means for calculating a channel gain for each orbital angular momentum mode-transmitter circle pairing based on the one or more parameters.

In some examples, the transmitter circle of the set of multiple transmitter circles for the orbital angular momentum mode of the set of multiple orbital angular momentum modes is determined based on the channel gain calculated for each for a respective orbital angular momentum mode-transmitter circle pairing.

In some examples, to support receiving the indication of the one or more parameters, the parameter reception manager 1025 may be configured as or otherwise support a means for receiving, from the second device, the indication of the one or more parameters via a RRC message, a MAC element message, a DCI message, an UCI message, a SCI message, or a combination thereof.

In some examples, the OAM transmission manager 1035 may be configured as or otherwise support a means for transmitting, to the second device, a configuration message indicating the transmitter circle determined for the orbital angular momentum mode.

Additionally or alternatively, the communications manager 1020 may support wireless communications at a second device in accordance with examples as disclosed herein. The parameter determination component 1040 may be configured as or otherwise support a means for determining one or more parameters associated with communications between the second device and a first device. The parameter indication component 1045 may be configured as or otherwise support a means for transmitting, to the first device, an indication of the one or more parameters determined by the second device. In some examples, the OAM transmission manager 1035 may be configured as or otherwise support a means for receiving a message from the first device via a transmitter circle of a set of multiple transmitter circles according to an orbital angular momentum mode of a set of multiple orbital angular momentum modes.

In some examples, the reference signal manager 1050 may be configured as or otherwise support a means for receiving a reference signal via a center transmitter circle of the set of multiple transmitter circles, the center transmitter circle being at a center of one or more of the set of multiple transmitter circles, where the one or more parameters are based on the reference signal.

In some examples, to support receiving the reference signal, the reference signal manager 1050 may be configured as or otherwise support a means for receiving the reference signal using a set of reference signal resources for the reference signal, where the reference signal, the set of reference signal resources, or both are unique to the transmitter circle.

In some examples, the reference signal manager 1050 may be configured as or otherwise support a means for receiving one or more reference signals according to a respective orbital angular momentum mode of the set of multiple orbital angular momentum modes via each transmitter circle of the set of multiple transmitter circles. In some examples, the channel gain calculation manager 1060 may be configured as or otherwise support a means for transmitting a set of multiple channel gain measurements, each channel gain measurement associated with a respective orbital angular momentum mode-transmitter circle pairing based on the one or more reference signals. In some examples, the power loading component 1055 may be configured as or otherwise support a means for receiving one or more messages from the second device using one or more transmitter circles according to a power loading scheme based on the set of multiple channel gain measurements, the power loading scheme associated with one or more orbital angular momentum modes of the set of multiple orbital angular momentum modes.

In some examples, the reference signal manager 1050 may be configured as or otherwise support a means for receiving a first reference signal of a first polarization according to a first orbital angular momentum mode of the set of multiple orbital angular momentum modes using the transmitter circle of the set of multiple transmitter circles. In some examples, the reference signal manager 1050 may be configured as or otherwise support a means for receiving a second reference signal of a second polarization according to the first orbital angular momentum mode of the set of multiple orbital angular momentum modes using the transmitter circle of the set of multiple transmitter circles, the second polarization different from the first polarization.

In some examples, the data stream receiver 1070 may be configured as or otherwise support a means for receiving a first data stream of the first polarization according to the first orbital angular momentum mode using the transmitter circle. In some examples, the data stream receiver 1070 may be configured as or otherwise support a means for receiving a second data stream of the second polarization according to the first orbital angular momentum mode using the transmitter circle.

In some examples, the orbital angular momentum mode is associated with mode 0. In some examples, the transmitter circle includes at least a center transmitter circle of the set of multiple transmitter circles, the center transmitter circle being at a center of one or more of the set of multiple transmitter circles.

In some examples, the reference signal manager 1050 may be configured as or otherwise support a means for receiving one or more reference signals according to a respective orbital angular momentum mode of the set of multiple orbital angular momentum modes via each transmitter circle of the set of multiple transmitter circles.

In some examples, the reference signal manager 1050 may be configured as or otherwise support a means for receiving an indication of an association between a set of reference signal resources for the one or more reference signals and a respective orbital angular momentum mode-transmitter circle pairing.

In some examples, the channel gain calculation manager 1060 may be configured as or otherwise support a means for calculating a channel gain measurement for each reference signal received by the second device, the channel gain measurement associated with an orbital angular momentum mode-transmitter circle pairing.

In some examples, the transmitter circle determination manager 1030 may be configured as or otherwise support a means for selecting a transmitter circle of the set of multiple transmitter circles for each orbital angular momentum mode of the set of multiple orbital angular momentum modes based on the channel gain measurement calculated for each reference signal received by the second device.

In some examples, to support transmitting the indication of the one or more parameters, the transmitter circle determination manager 1030 may be configured as or otherwise support a means for transmitting an indication of a respective transmitter circle selected for each orbital angular momentum mode of the set of multiple orbital angular momentum modes.

In some examples, to support transmitting the indication of the one or more parameters, the channel gain calculation manager 1060 may be configured as or otherwise support a means for transmitting the channel gain measurement associated with each received reference signal.

In some examples, to support transmitting the indication of the one or more parameters, the channel gain calculation manager 1060 may be configured as or otherwise support a means for transmitting the channel gain measurement associated with each mode, where the channel gain measurement is a highest channel gain measurement associated with the mode.

In some examples, the parameter determination component 1040 may be configured as or otherwise support a means for determining one or more channel parameters, one or more receiver device parameters, or both.

In some examples, to support transmitting the indication of the one or more parameters, the parameter indication component 1045 may be configured as or otherwise support a means for transmitting an indication of the one or more channel parameters, or the one or more receiver device parameters, or both.

In some examples, the one or more channel parameters includes a path loss measurement between the second device and the first device, or a communication distance between the second device and the first device, or both, and where the one or more receiver device parameters includes a radius of one or more receiver circles of the second device.

In some examples, to support transmitting the indication of the one or more parameters, the parameter indication component 1045 may be configured as or otherwise support a means for transmitting, to the first device, the indication of the one or more parameters via a RRC message, a MAC CE message, a DCI message, an UCI message, a SCI message, or a combination thereof.

In some examples, the OAM transmission manager 1035 may be configured as or otherwise support a means for receiving, from the first device, a configuration message indicating orbital angular momentum mode-transmitter circle pairings, where the second device receives the message based on the configuration message.

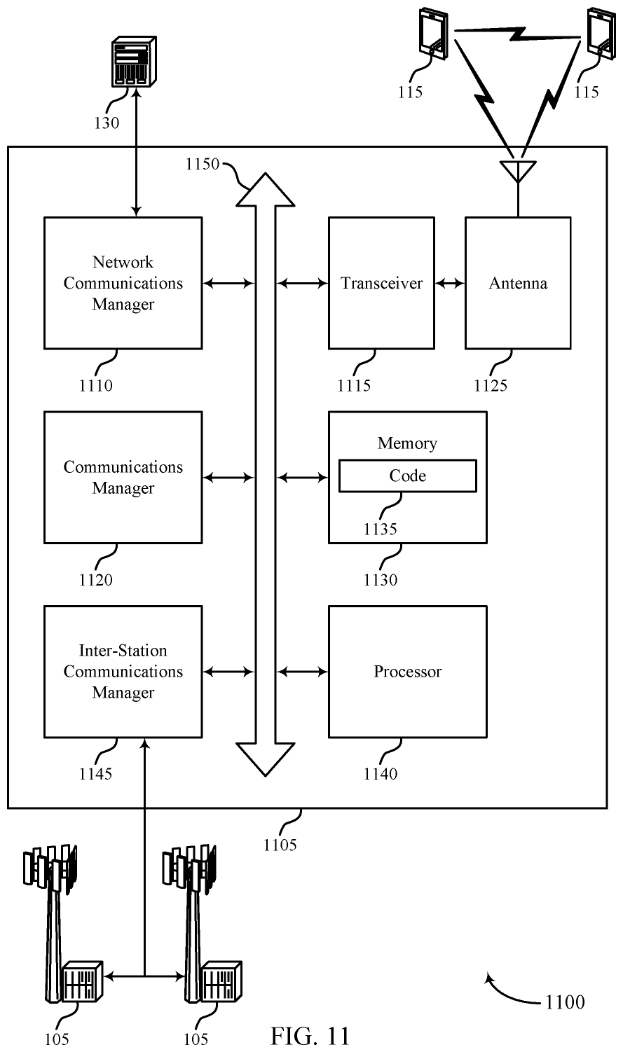

FIG. 11 shows a diagram of a system 1100 including a device 1105 that supports orbital angular momentum transmitter circle selection in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic input/output (I/O) system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting orbital angular momentum transmitter circle selection). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communications at a first device in accordance with examples as disclosed herein. For example, the communications manager 1120 may be configured as or otherwise support a means for receiving, from a second device, an indication of one or more parameters associated with communications between the second device and the first device. The communications manager 1120 may be configured as or otherwise support a means for determining a transmitter circle of a set of multiple transmitter circles for an orbital angular momentum mode of a set of multiple orbital angular momentum modes for communications with the second device based on the one or more parameters. The communications manager 1120 may be configured as or otherwise support a means for transmitting a message to the second device using the transmitter circle according to the orbital angular momentum mode based on the determining.

Additionally or alternatively, the communications manager 1120 may support wireless communications at a second device in accordance with examples as disclosed herein. For example, the communications manager 1120 may be configured as or otherwise support a means for determining one or more parameters associated with communications between the second device and a first device. The communications manager 1120 may be configured as or otherwise support a means for transmitting, to the first device, an indication of the one or more parameters determined by the second device. The communications manager 1120 may be configured as or otherwise support a means for receiving a message from the first device via a transmitter circle of a set of multiple transmitter circles according to an orbital angular momentum mode of a set of multiple orbital angular momentum modes.

By including or configuring the communications manager 1120 in accordance with examples as described herein, the device 1105 may support techniques for improved spectral efficiency and higher throughput based on using one or more UCAs to multiplex OAM transmissions with different OAM states, polarizations, or both.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of orbital angular momentum transmitter circle selection as described herein, or the processor 1140 and the memory 1130 may be otherwise configured to perform or support such operations.

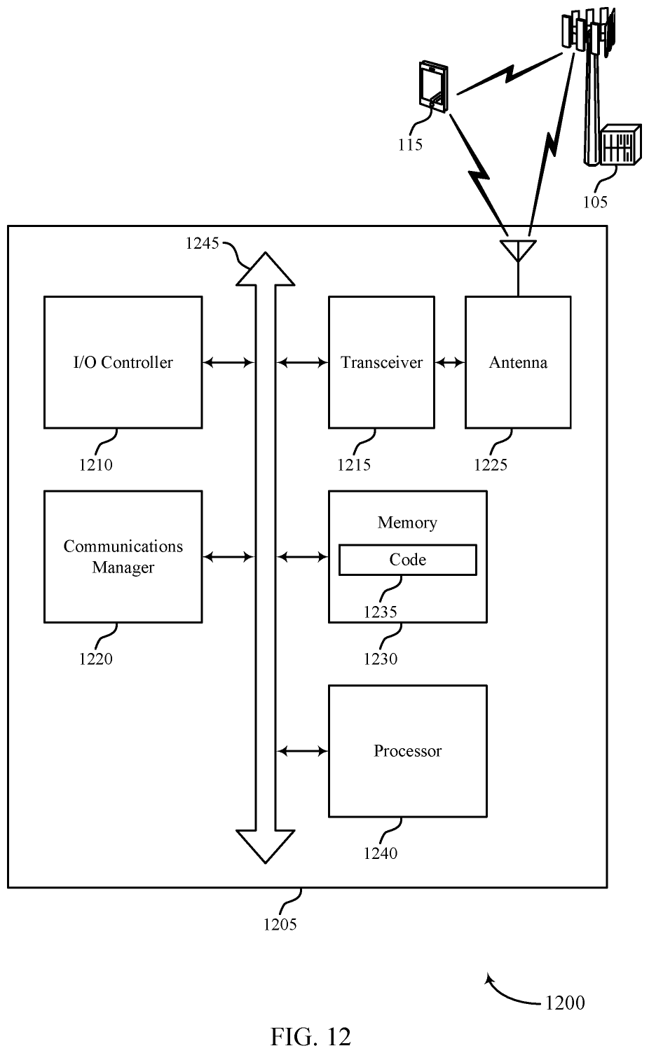

FIG. 12 shows a diagram of a system 1200 including a device 1205 that supports orbital angular momentum transmitter circle selection in accordance with aspects of the present disclosure. The device 1205 may be an example of or include the components of a device 805, a device 905, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an I/O controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 815, a transmitter 915, a receiver 810, a receiver 910, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting orbital angular momentum transmitter circle selection). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a first device in accordance with examples as disclosed herein. For example, the communications manager 1220 may be configured as or otherwise support a means for receiving, from a second device, an indication of one or more parameters associated with communications between the second device and the first device. The communications manager 1220 may be configured as or otherwise support a means for determining a transmitter circle of a set of multiple transmitter circles for an orbital angular momentum mode of a set of multiple orbital angular momentum modes for communications with the second device based on the one or more parameters. The communications manager 1220 may be configured as or otherwise support a means for transmitting a message to the second device using the transmitter circle according to the orbital angular momentum mode based on the determining.

Additionally or alternatively, the communications manager 1220 may support wireless communications at a second device in accordance with examples as disclosed herein. For example, the communications manager 1220 may be configured as or otherwise support a means for determining one or more parameters associated with communications between the second device and a first device. The communications manager 1220 may be configured as or otherwise support a means for transmitting, to the first device, an indication of the one or more parameters determined by the second device. The communications manager 1220 may be configured as or otherwise support a means for receiving a message from the first device via a transmitter circle of a set of multiple transmitter circles according to an orbital angular momentum mode of a set of multiple orbital angular momentum modes.

By including or configuring the communications manager 1220 in accordance with examples as described herein, the device 1205 may support techniques for improved spectral efficiency and higher throughput based on using one or more UCAs to multiplex OAM transmissions with different OAM states, polarizations, or both.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of orbital angular momentum transmitter circle selection as described herein, or the processor 1240 and the memory 1230 may be otherwise configured to perform or support such operations.

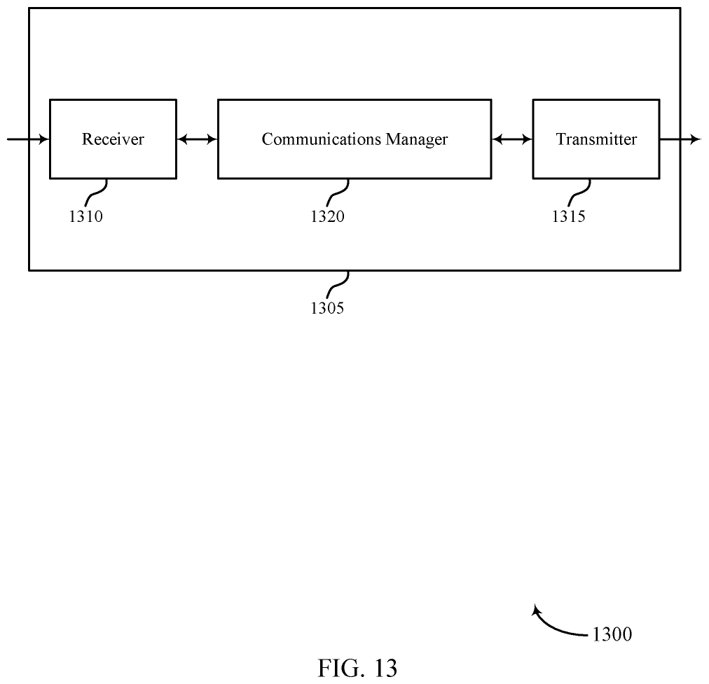

FIG. 13 shows a block diagram 1300 of a device 1305 that supports orbital angular momentum transmitter circle selection in accordance with aspects of the present disclosure. The device 1305 may be an example of aspects of a UE 115 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to orbital angular momentum transmitter circle selection). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to orbital angular momentum transmitter circle selection). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of orbital angular momentum transmitter circle selection as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a first device in accordance with examples as disclosed herein. For example, the communications manager 1320 may be configured as or otherwise support a means for receiving, from a second device, an indication of one or more parameters associated with communications between the second device and the first device. The communications manager 1320 may be configured as or otherwise support a means for determining a transmitter circle of a set of multiple transmitter circles for an orbital angular momentum mode of a set of multiple orbital angular momentum modes for communications with the second device based on the one or more parameters. The communications manager 1320 may be configured as or otherwise support a means for transmitting a message to the second device using the transmitter circle according to the orbital angular momentum mode based on the determining.

Additionally or alternatively, the communications manager 1320 may support wireless communications at a second device in accordance with examples as disclosed herein. For example, the communications manager 1320 may be configured as or otherwise support a means for determining one or more parameters associated with communications between the second device and a first device. The communications manager 1320 may be configured as or otherwise support a means for transmitting, to the first device, an indication of the one or more parameters determined by the second device. The communications manager 1320 may be configured as or otherwise support a means for receiving a message from the first device via a transmitter circle of a set of multiple transmitter circles according to an orbital angular momentum mode of a set of multiple orbital angular momentum modes.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for more efficient utilization of communication resources based on using one or more UCAs to multiplex OAM transmissions with different OAM states, polarizations, or both.

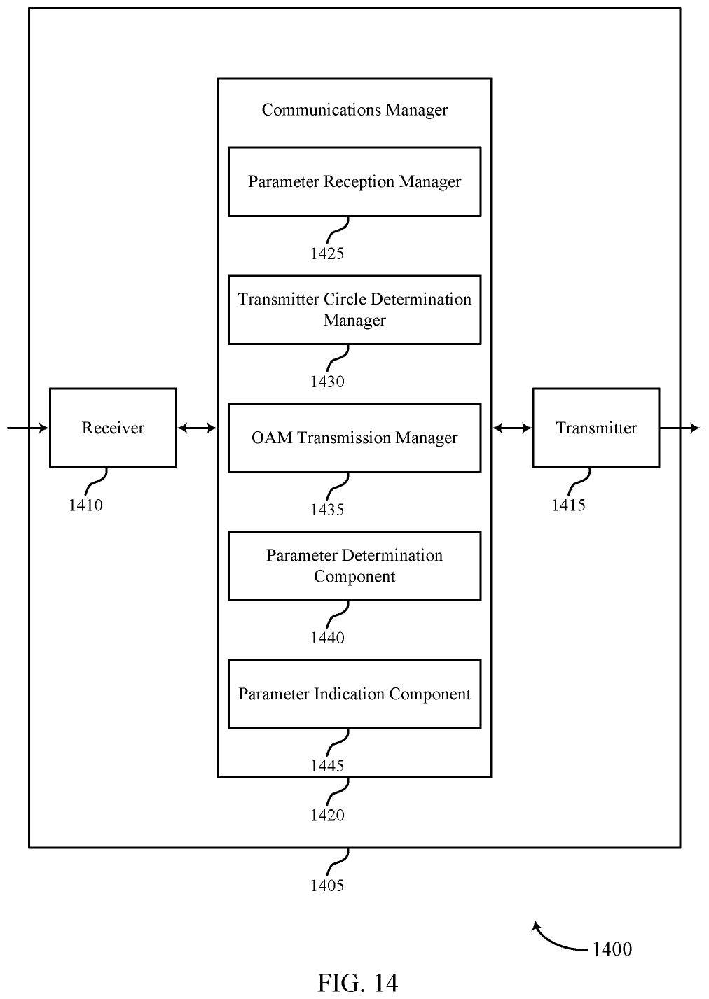

FIG. 14 shows a block diagram 1400 of a device 1405 that supports orbital angular momentum transmitter circle selection in accordance with aspects of the present disclosure. The device 1405 may be an example of aspects of a device 1305, a UE 115, or a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to orbital angular momentum transmitter circle selection). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to orbital angular momentum transmitter circle selection). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of orbital angular momentum transmitter circle selection as described herein. For example, the communications manager 1420 may include a parameter reception manager 1425, a transmitter circle determination manager 1430, a OAM transmission manager 1435, a parameter determination component 1440, a parameter indication component 1445, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a first device in accordance with examples as disclosed herein. The parameter reception manager 1425 may be configured as or otherwise support a means for receiving, from a second device, an indication of one or more parameters associated with communications between the second device and the first device. The transmitter circle determination manager 1430 may be configured as or otherwise support a means for determining a transmitter circle of a set of multiple transmitter circles for an orbital angular momentum mode of a set of multiple orbital angular momentum modes for communications with the second device based on the one or more parameters. The OAM transmission manager 1435 may be configured as or otherwise support a means for transmitting a message to the second device using the transmitter circle according to the orbital angular momentum mode based on the determining.

Additionally or alternatively, the communications manager 1420 may support wireless communications at a second device in accordance with examples as disclosed herein. The parameter determination component 1440 may be configured as or otherwise support a means for determining one or more parameters associated with communications between the second device and a first device. The parameter indication component 1445 may be configured as or otherwise support a means for transmitting, to the first device, an indication of the one or more parameters determined by the second device. The OAM transmission manager 1435 may be configured as or otherwise support a means for receiving a message from the first device via a transmitter circle of a set of multiple transmitter circles according to an orbital angular momentum mode of a set of multiple orbital angular momentum modes.

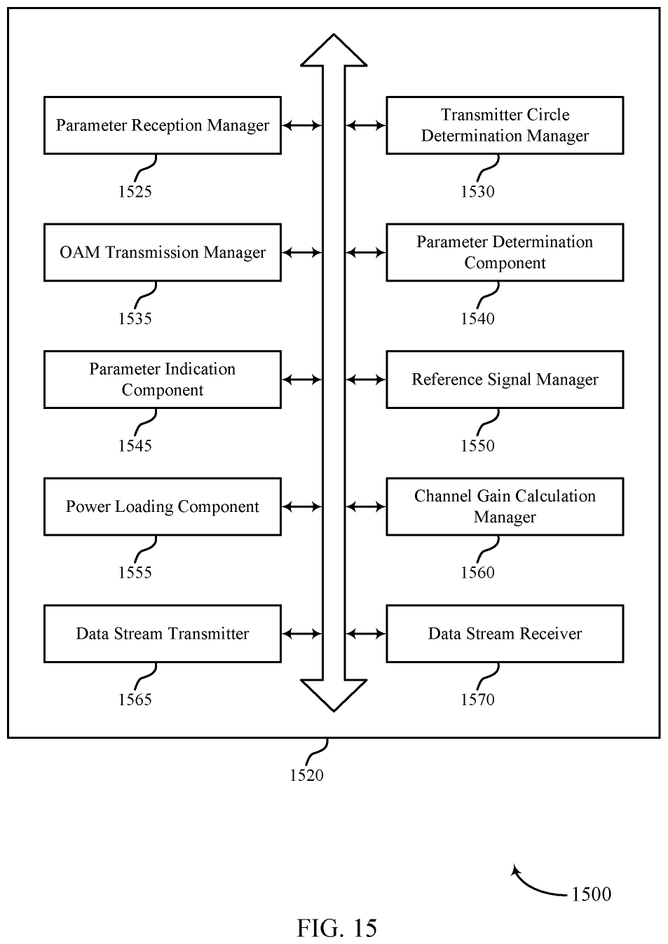

FIG. 15 shows a block diagram 1500 of a communications manager 1520 that supports orbital angular momentum transmitter circle selection in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of orbital angular momentum transmitter circle selection as described herein. For example, the communications manager 1520 may include a parameter reception manager 1525, a transmitter circle determination manager 1530, a OAM transmission manager 1535, a parameter determination component 1540, a parameter indication component 1545, a reference signal manager 1550, a power loading component 1555, a channel gain calculation manager 1560, a data stream transmitter 1565, a data stream receiver 1570, or any combination thereof. Each of these components may communicate, directly or indirectly, with one another (e.g., via one or more buses).

The communications manager 1520 may support wireless communications at a first device in accordance with examples as disclosed herein. The parameter reception manager 1525 may be configured as or otherwise support a means for receiving, from a second device, an indication of one or more parameters associated with communications between the second device and the first device. The transmitter circle determination manager 1530 may be configured as or otherwise support a means for determining a transmitter circle of a set of multiple transmitter circles for an orbital angular momentum mode of a set of multiple orbital angular momentum modes for communications with the second device based on the one or more parameters. The OAM transmission manager 1535 may be configured as or otherwise support a means for transmitting a message to the second device using the transmitter circle according to the orbital angular momentum mode based on the determining.

In some examples, the reference signal manager 1550 may be configured as or otherwise support a means for transmitting a reference signal using a center transmitter circle of the set of multiple transmitter circles, the center transmitter circle being at a center of one or more of the set of multiple transmitter circles, where the transmitter circle is determined based on the reference signal.

In some examples, to support transmitting the reference signal, the reference signal manager 1550 may be configured as or otherwise support a means for transmitting the reference signal using a set of reference signal resources for the reference signal, where the reference signal, the set of reference signal resources, or both are unique to the transmitter circle.

In some examples, the reference signal manager 1550 may be configured as or otherwise support a means for transmitting one or more reference signals according to a respective orbital angular momentum mode of the set of multiple orbital angular momentum modes via each transmitter circle of the set of multiple transmitter circles. In some examples, the parameter reception manager 1525 may be configured as or otherwise support a means for receiving a set of multiple channel gain measurements, each channel gain measurement associated with a respective orbital angular momentum mode-transmitter circle pairing based on the one or more reference signals. In some examples, the power loading component 1555 may be configured as or otherwise support a means for transmitting one or more messages to the second device using one or more transmitter circles according to a power loading scheme based on the set of multiple channel gain measurements, the power loading scheme associated with one or more orbital angular momentum modes of the set of multiple orbital angular momentum modes.

In some examples, the reference signal manager 1550 may be configured as or otherwise support a means for transmitting a first reference signal of a first polarization according to a first orbital angular momentum mode of the set of multiple orbital angular momentum modes using the transmitter circle of the set of multiple transmitter circles. In some examples, the reference signal manager 1550 may be configured as or otherwise support a means for transmitting a second reference signal of a second polarization according to the first orbital angular momentum mode of the set of multiple orbital angular momentum modes using the transmitter circle of the set of multiple transmitter circles, the second polarization different from the first polarization.

In some examples, the data stream transmitter 1565 may be configured as or otherwise support a means for transmitting a first data stream of the first polarization according to the first orbital angular momentum mode using the transmitter circle. In some examples, the data stream transmitter 1565 may be configured as or otherwise support a means for transmitting a second data stream of the second polarization according to the first orbital angular momentum mode using the transmitter circle.

In some examples, the transmitter circle includes a set of multiple antenna sub-arrays, each antenna sub-array including a first antenna element associated with transmissions of the first polarization and a second antenna element associated with transmissions of the second polarization. In some examples, each of the first and second reference signals is transmitted using a respective antenna sub-array of the set of multiple antenna sub-arrays.

In some examples, the orbital angular momentum mode is associated with mode 0. In some examples, the transmitter circle includes at least a center transmitter circle of the set of multiple transmitter circles, the center transmitter circle being at a center of one or more of the set of multiple transmitter circles.

In some examples, the reference signal manager 1550 may be configured as or otherwise support a means for transmitting one or more reference signals according to a respective orbital angular momentum mode of the set of multiple orbital angular momentum modes via each transmitter circle of the set of multiple transmitter circles.

In some examples, the reference signal manager 1550 may be configured as or otherwise support a means for transmitting an indication of an association between a set of reference signal resources for the one or more reference signals and a respective orbital angular momentum mode-transmitter circle pairing.

In some examples, to support receiving the indication of one or more parameters, the parameter reception manager 1525 may be configured as or otherwise support a means for receiving an indication of a respective transmitter circle for each orbital angular momentum mode of the set of multiple orbital angular momentum modes based on the one or more reference signals.

In some examples, the parameter reception manager 1525 may be configured as or otherwise support a means for receiving a set of multiple channel gain measurements, each channel gain measurement associated with a respective orbital angular momentum mode-transmitter circle pairing.

In some examples, the transmitter circle of the set of multiple transmitter circles for the orbital angular momentum mode of the set of multiple orbital angular momentum modes is determined based on the indication of the transmitter circle selected for each orbital angular momentum mode, or the set of multiple channel gain measurements, or both.

In some examples, to support receiving the indication of one or more parameters, the parameter reception manager 1525 may be configured as or otherwise support a means for receiving a channel gain measurement associated with each transmitted reference signal.

In some examples, to support receiving the indication of one or more parameters, the parameter reception manager 1525 may be configured as or otherwise support a means for receiving a channel gain measurement associated with each mode, where the channel gain measurement is a highest channel gain measurement associated with the mode.

In some examples, to support receiving the indication of the one or more parameters, the parameter reception manager 1525 may be configured as or otherwise support a means for receiving an indication of one or more channel parameters, or one or more receiver device parameters, or both.

In some examples, the one or more channel parameters include a path loss measurement between the second device and the first device, or a communication distance between the second device and the first device, or both.

In some examples, the one or more receiver device parameters includes a radius of one or more receiver circles of the second device.

In some examples, the channel gain calculation manager 1560 may be configured as or otherwise support a means for calculating a channel gain for each orbital angular momentum mode-transmitter circle pairing based on the one or more parameters.

In some examples, the transmitter circle of the set of multiple transmitter circles for the orbital angular momentum mode of the set of multiple orbital angular momentum modes is determined based on the channel gain calculated for each for a respective orbital angular momentum mode-transmitter circle pairing.

In some examples, to support receiving the indication of the one or more parameters, the parameter reception manager 1525 may be configured as or otherwise support a means for receiving, from the second device, the indication of the one or more parameters via a RRC message, a MAC CE message, a DCI message, an UCI message, a SCI message, or a combination thereof.

In some examples, the OAM transmission manager 1535 may be configured as or otherwise support a means for transmitting, to the second device, a configuration message indicating the transmitter circle determined for the orbital angular momentum mode.

Additionally or alternatively, the communications manager 1520 may support wireless communications at a second device in accordance with examples as disclosed herein. The parameter determination component 1540 may be configured as or otherwise support a means for determining one or more parameters associated with communications between the second device and a first device. The parameter indication component 1545 may be configured as or otherwise support a means for transmitting, to the first device, an indication of the one or more parameters determined by the second device. In some examples, the OAM transmission manager 1535 may be configured as or otherwise support a means for receiving a message from the first device via a transmitter circle of a set of multiple transmitter circles according to an orbital angular momentum mode of a set of multiple orbital angular momentum modes.

In some examples, the reference signal manager 1550 may be configured as or otherwise support a means for receiving a reference signal via a center transmitter circle of the set of multiple transmitter circles, the center transmitter circle being at a center of one or more of the set of multiple transmitter circles, where the one or more parameters are based on the reference signal.

In some examples, to support receiving the reference signal, the reference signal manager 1550 may be configured as or otherwise support a means for receiving the reference signal using a set of reference signal resources for the reference signal, where the reference signal, the set of reference signal resources, or both are unique to the transmitter circle.

In some examples, the reference signal manager 1550 may be configured as or otherwise support a means for receiving one or more reference signals according to a respective orbital angular momentum mode of the set of multiple orbital angular momentum modes via each transmitter circle of the set of multiple transmitter circles. In some examples, the channel gain calculation manager 1560 may be configured as or otherwise support a means for transmitting a set of multiple channel gain measurements, each channel gain measurement associated with a respective orbital angular momentum mode-transmitter circle pairing based on the one or more reference signals. In some examples, the power loading component 1555 may be configured as or otherwise support a means for receiving one or more messages from the second device using one or more transmitter circles according to a power loading scheme based on the set of multiple channel gain measurements, the power loading scheme associated with one or more orbital angular momentum modes of the set of multiple orbital angular momentum modes.

In some examples, the reference signal manager 1550 may be configured as or otherwise support a means for receiving a first reference signal of a first polarization according to a first orbital angular momentum mode of the set of multiple orbital angular momentum modes using the transmitter circle of the set of multiple transmitter circles. In some examples, the reference signal manager 1550 may be configured as or otherwise support a means for receiving a second reference signal of a second polarization according to the first orbital angular momentum mode of the set of multiple orbital angular momentum modes using the transmitter circle of the set of multiple transmitter circles, the second polarization different from the first polarization.

In some examples, the data stream receiver 1570 may be configured as or otherwise support a means for receiving a first data stream of the first polarization according to the first orbital angular momentum mode using the transmitter circle. In some examples, the data stream receiver 1570 may be configured as or otherwise support a means for receiving a second data stream of the second polarization according to the first orbital angular momentum mode using the transmitter circle.

In some examples, the orbital angular momentum mode is associated with mode 0. In some examples, the transmitter circle includes at least a center transmitter circle of the set of multiple transmitter circles, the center transmitter circle being at a center of one or more of the set of multiple transmitter circles.

In some examples, the reference signal manager 1550 may be configured as or otherwise support a means for receiving one or more reference signals according to a respective orbital angular momentum mode of the set of multiple orbital angular momentum modes via each transmitter circle of the set of multiple transmitter circles.

In some examples, the reference signal manager 1550 may be configured as or otherwise support a means for receiving an indication of an association between a set of reference signal resources for the one or more reference signals and a respective orbital angular momentum mode-transmitter circle pairing.

In some examples, the channel gain calculation manager 1560 may be configured as or otherwise support a means for calculating a channel gain measurement for each reference signal received by the second device, the channel gain measurement associated with an orbital angular momentum mode-transmitter circle pairing.

In some examples, the transmitter circle determination manager 1530 may be configured as or otherwise support a means for selecting a transmitter circle of the set of multiple transmitter circles for each orbital angular momentum mode of the set of multiple orbital angular momentum modes based on the channel gain measurement calculated for each reference signal received by the second device.

In some examples, to support transmitting the indication of the one or more parameters, the transmitter circle determination manager 1530 may be configured as or otherwise support a means for transmitting an indication of a respective transmitter circle selected for each orbital angular momentum mode of the set of multiple orbital angular momentum modes.

In some examples, to support transmitting the indication of the one or more parameters, the channel gain calculation manager 1560 may be configured as or otherwise support a means for transmitting the channel gain measurement associated with each received reference signal.

In some examples, to support transmitting the indication of the one or more parameters, the channel gain calculation manager 1560 may be configured as or otherwise support a means for transmitting the channel gain measurement associated with each mode, where the channel gain measurement is a highest channel gain measurement associated with the mode.

In some examples, the parameter determination component 1540 may be configured as or otherwise support a means for determining one or more channel parameters, one or more receiver device parameters, or both.

In some examples, to support transmitting the indication of the one or more parameters, the parameter indication component 1545 may be configured as or otherwise support a means for transmitting an indication of the one or more channel parameters, or the one or more receiver device parameters, or both.

In some examples, the one or more channel parameters includes a path loss measurement between the second device and the first device, or a communication distance between the second device and the first device, or both, and where the one or more receiver device parameters includes a radius of one or more receiver circles of the second device.

In some examples, to support transmitting the indication of the one or more parameters, the parameter indication component 1545 may be configured as or otherwise support a means for transmitting, to the first device, the indication of the one or more parameters via a RRC message, a MAC CE message, a DCI message, an UCI message, a SCI message, or a combination thereof.

In some examples, the OAM transmission manager 1535 may be configured as or otherwise support a means for receiving, from the first device, a configuration message indicating orbital angular momentum mode-transmitter circle pairings, where the second device receives the message based on the configuration message.

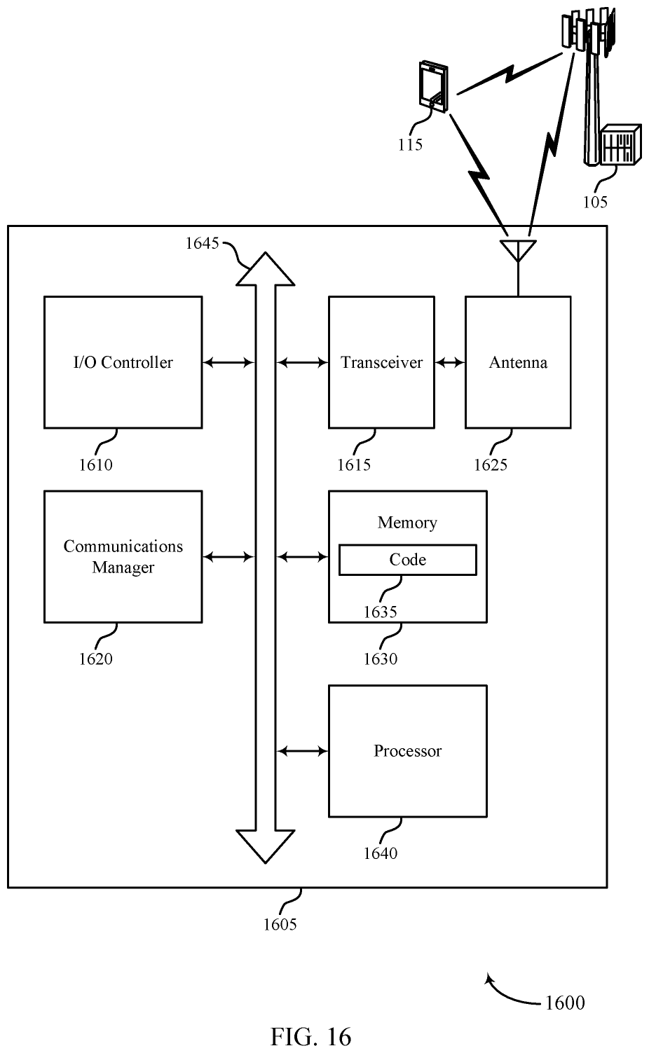

FIG. 16 shows a diagram of a system 1600 including a device 1605 that supports orbital angular momentum transmitter circle selection in accordance with aspects of the present disclosure. The device 1605 may be an example of or include the components of a device 1305, a device 1405, or a UE 115 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting orbital angular momentum transmitter circle selection). For example, the device 1605 or a component of the device 1605 may include a processor 1640 and memory 1630 coupled to the processor 1640, the processor 1640 and memory 1630 configured to perform various functions described herein.

The communications manager 1620 may support wireless communications at a first device in accordance with examples as disclosed herein. For example, the communications manager 1620 may be configured as or otherwise support a means for receiving, from a second device, an indication of one or more parameters associated with communications between the second device and the first device. The communications manager 1620 may be configured as or otherwise support a means for determining a transmitter circle of a set of multiple transmitter circles for an orbital angular momentum mode of a set of multiple orbital angular momentum modes for communications with the second device based on the one or more parameters. The communications manager 1620 may be configured as or otherwise support a means for transmitting a message to the second device using the transmitter circle according to the orbital angular momentum mode based on the determining.

Additionally or alternatively, the communications manager 1620 may support wireless communications at a second device in accordance with examples as disclosed herein. For example, the communications manager 1620 may be configured as or otherwise support a means for determining one or more parameters associated with communications between the second device and a first device. The communications manager 1620 may be configured as or otherwise support a means for transmitting, to the first device, an indication of the one or more parameters determined by the second device. The communications manager 1620 may be configured as or otherwise support a means for receiving a message from the first device via a transmitter circle of a set of multiple transmitter circles according to an orbital angular momentum mode of a set of multiple orbital angular momentum modes.

By including or configuring the communications manager 1620 in accordance with examples as described herein, the device 1605 may support techniques for improved spectral efficiency and higher throughput based on using one or more UCAs to multiplex OAM transmissions with different OAM states, polarizations, or both.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of orbital angular momentum transmitter circle selection as described herein, or the processor 1640 and the memory 1630 may be otherwise configured to perform or support such operations.

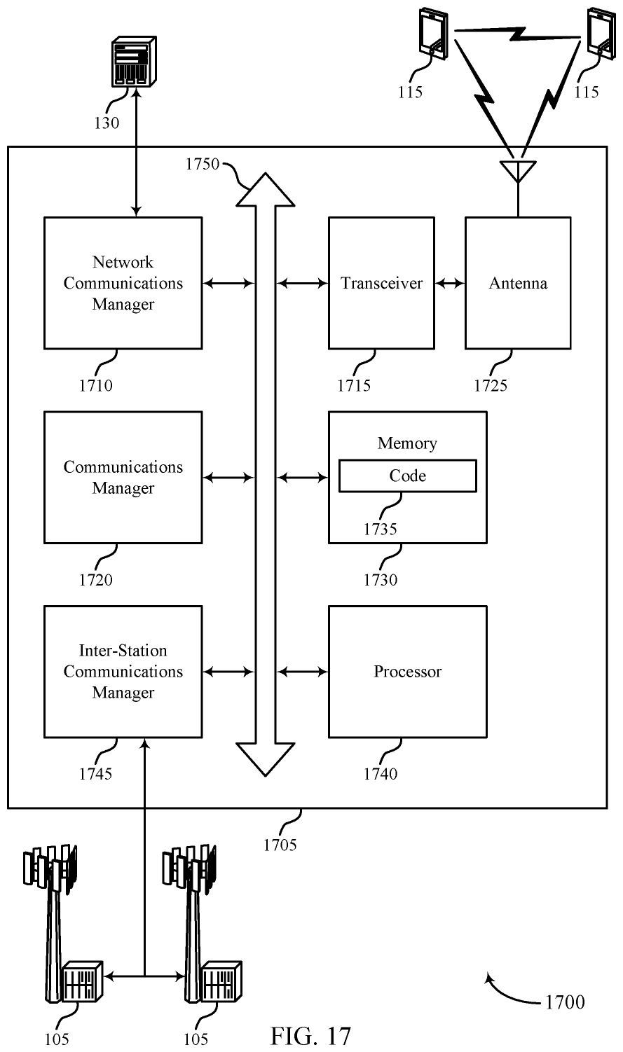

FIG. 17 shows a diagram of a system 1700 including a device 1705 that supports orbital angular momentum transmitter circle selection in accordance with aspects of the present disclosure. The device 1705 may be an example of or include the components of a device 1305, a device 1405, or a base station 105 as described herein. The device 1705 may communicate wirelessly with one or more base stations 105, UEs 115, or any combination thereof. The device 1705 may include components for bi-directional voice and data communications including components for transmitting and receiving communications, such as a communications manager 1720, a network communications manager 1710, a transceiver 1715, an antenna 1725, a memory 1730, code 1735, a processor 1740, and an inter-station communications manager 1745. These components may be in electronic communication or otherwise coupled (e.g., operatively, communicatively, functionally, electronically, electrically) via one or more buses (e.g., a bus 1750).

The network communications manager 1710 may manage communications with a core network 130 (e.g., via one or more wired backhaul links). For example, the network communications manager 1710 may manage the transfer of data communications for client devices, such as one or more UEs 115.

In some cases, the device 1705 may include a single antenna 1725. However, in some other cases the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1315, a transmitter 1415, a receiver 1310, a receiver 1410, or any combination thereof or component thereof, as described herein.

The memory 1730 may include RAM and ROM. The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a BIOS which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting orbital angular momentum transmitter circle selection). For example, the device 1705 or a component of the device 1705 may include a processor 1740 and memory 1730 coupled to the processor 1740, the processor 1740 and memory 1730 configured to perform various functions described herein.

The inter-station communications manager 1745 may manage communications with other base stations 105, and may include a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communications network technology to provide communication between base stations 105.

The communications manager 1720 may support wireless communications at a first device in accordance with examples as disclosed herein. For example, the communications manager 1720 may be configured as or otherwise support a means for receiving, from a second device, an indication of one or more parameters associated with communications between the second device and the first device. The communications manager 1720 may be configured as or otherwise support a means for determining a transmitter circle of a set of multiple transmitter circles for an orbital angular momentum mode of a set of multiple orbital angular momentum modes for communications with the second device based on the one or more parameters. The communications manager 1720 may be configured as or otherwise support a means for transmitting a message to the second device using the transmitter circle according to the orbital angular momentum mode based on the determining.

Additionally or alternatively, the communications manager 1720 may support wireless communications at a second device in accordance with examples as disclosed herein. For example, the communications manager 1720 may be configured as or otherwise support a means for determining one or more parameters associated with communications between the second device and a first device. The communications manager 1720 may be configured as or otherwise support a means for transmitting, to the first device, an indication of the one or more parameters determined by the second device. The communications manager 1720 may be configured as or otherwise support a means for receiving a message from the first device via a transmitter circle of a set of multiple transmitter circles according to an orbital angular momentum mode of a set of multiple orbital angular momentum modes.

By including or configuring the communications manager 1720 in accordance with examples as described herein, the device 1705 may support techniques for improved spectral efficiency and higher throughput based on using one or more UCAs to multiplex OAM transmissions with different OAM states, polarizations, or both.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of orbital angular momentum transmitter circle selection as described herein, or the processor 1740 and the memory 1730 may be otherwise configured to perform or support such operations.

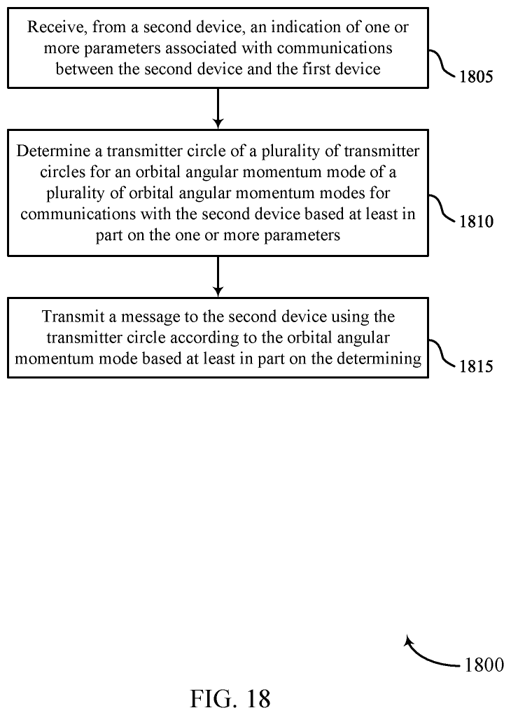

FIG. 18 shows a flowchart illustrating a method 1800 that supports orbital angular momentum transmitter circle selection in accordance with aspects of the present disclosure. The operations of the method 1800 may be implemented by a base station or a UE or its components as described herein. For example, the operations of the method 1800 may be performed by a base station 105 or a UE 115 as described with reference to FIGS. 1 through 12. In some examples, a base station or a UE may execute a set of instructions to control the functional elements of the base station or the UE to perform the described functions. Additionally or alternatively, the base station or the UE may perform aspects of the described functions using special-purpose hardware.

At 1805, the method may include receiving, from a second device, an indication of one or more parameters associated with communications between the second device and the first device. The operations of 1805 may be performed in accordance with examples as disclosed herein. In some examples, aspects of the operations of 1805 may be performed by a parameter reception manager 1025 as described with reference to FIG. 10.

At 1810, the method may include determining a transmitter circle of a set of multiple transmitter circles for an orbital angular momentum mode of a set of multiple orbital angular momentum modes for communications with the second device based on the one or more parameters. The operations of 1810 may be performed in accordance with examples as disclosed herein. In some examples, aspects of the operations of 1810 may be performed by a transmitter circle determination manager 1030 as described with reference to FIG. 10.

At 1815, the method may include transmitting a message to the second device using the transmitter circle according to the orbital angular momentum mode based on the determining. The operations of 1815 may be performed in accordance with examples as disclosed herein. In some examples, aspects of the operations of 1815 may be performed by a OAM transmission manager 1035 as described with reference to FIG. 10.

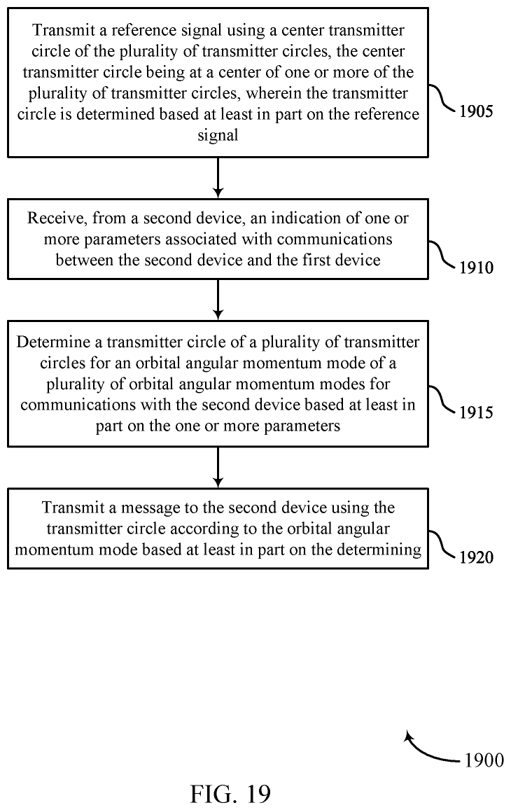

FIG. 19 shows a flowchart illustrating a method 1900 that supports orbital angular momentum transmitter circle selection in accordance with aspects of the present disclosure. The operations of the method 1900 may be implemented by a base station or a UE or its components as described herein. For example, the operations of the method 1900 may be performed by a base station 105 or a UE 115 as described with reference to FIGS. 1 through 12. In some examples, a base station or a UE may execute a set of instructions to control the functional elements of the base station or the UE to perform the described functions. Additionally or alternatively, the base station or the UE may perform aspects of the described functions using special-purpose hardware.

At 1905, the method may include transmitting a reference signal using a center transmitter circle of the set of multiple transmitter circles, the center transmitter circle being at a center of one or more of the set of multiple transmitter circles, where the transmitter circle is determined based on the reference signal. The operations of 1905 may be performed in accordance with examples as disclosed herein. In some examples, aspects of the operations of 1905 may be performed by a reference signal manager 1050 as described with reference to FIG. 10.

At 1910, the method may include receiving, from a second device, an indication of one or more parameters associated with communications between the second device and the first device. The operations of 1910 may be performed in accordance with examples as disclosed herein. In some examples, aspects of the operations of 1910 may be performed by a parameter reception manager 1025 as described with reference to FIG. 10.

At 1915, the method may include determining a transmitter circle of a set of multiple transmitter circles for an orbital angular momentum mode of a set of multiple orbital angular momentum modes for communications with the second device based on the one or more parameters. The operations of 1915 may be performed in accordance with examples as disclosed herein. In some examples, aspects of the operations of 1915 may be performed by a transmitter circle determination manager 1030 as described with reference to FIG. 10.

At 1920, the method may include transmitting a message to the second device using the transmitter circle according to the orbital angular momentum mode based on the determining. The operations of 1920 may be performed in accordance with examples as disclosed herein. In some examples, aspects of the operations of 1920 may be performed by a OAM transmission manager 1035 as described with reference to FIG. 10.

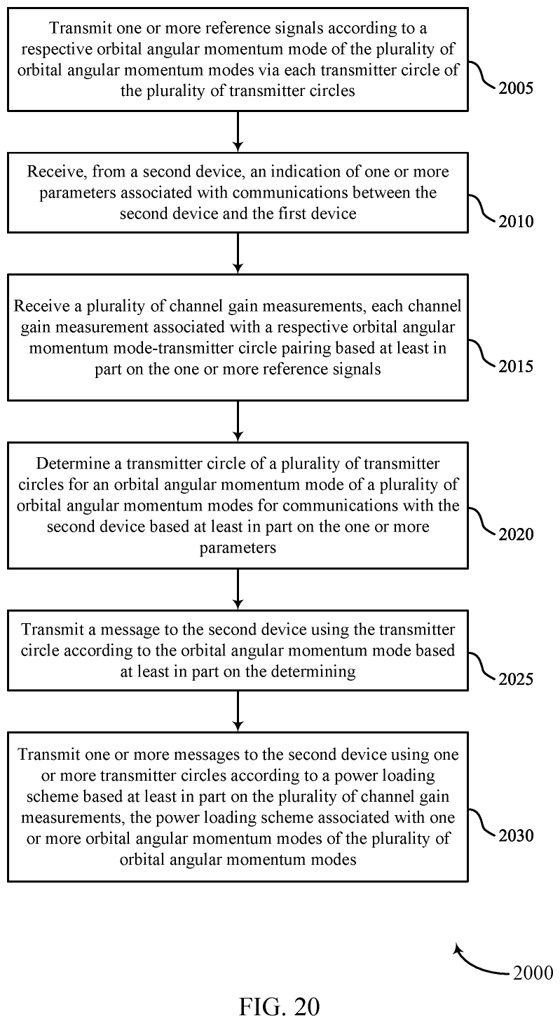

FIG. 20 shows a flowchart illustrating a method 2000 that supports orbital angular momentum transmitter circle selection in accordance with aspects of the present disclosure. The operations of the method 2000 may be implemented by a base station or a UE or its components as described herein. For example, the operations of the method 2000 may be performed by a base station 105 or a UE 115 as described with reference to FIGS. 1 through 12. In some examples, a base station or a UE may execute a set of instructions to control the functional elements of the base station or the UE to perform the described functions. Additionally or alternatively, the base station or the UE may perform aspects of the described functions using special-purpose hardware.

At 2005, the method may include transmitting one or more reference signals according to a respective orbital angular momentum mode of the set of multiple orbital angular momentum modes via each transmitter circle of the set of multiple transmitter circles. The operations of 2005 may be performed in accordance with examples as disclosed herein. In some examples, aspects of the operations of 2005 may be performed by a reference signal manager 1050 as described with reference to FIG. 10.

At 2010, the method may include receiving, from a second device, an indication of one or more parameters associated with communications between the second device and the first device. The operations of 2010 may be performed in accordance with examples as disclosed herein. In some examples, aspects of the operations of 2010 may be performed by a parameter reception manager 1025 as described with reference to FIG. 10.

At 2015, the method may include receiving a set of multiple channel gain measurements, each channel gain measurement associated with a respective orbital angular momentum mode-transmitter circle pairing based on the one or more reference signals. The operations of 2015 may be performed in accordance with examples as disclosed herein. In some examples, aspects of the operations of 2015 may be performed by a parameter reception manager 1025 as described with reference to FIG. 10.

At 2020, the method may include determining a transmitter circle of a set of multiple transmitter circles for an orbital angular momentum mode of a set of multiple orbital angular momentum modes for communications with the second device based on the one or more parameters. The operations of 2020 may be performed in accordance with examples as disclosed herein. In some examples, aspects of the operations of 2020 may be performed by a transmitter circle determination manager 1030 as described with reference to FIG. 10.

At 2025, the method may include transmitting a message to the second device using the transmitter circle according to the orbital angular momentum mode based on the determining. The operations of 2025 may be performed in accordance with examples as disclosed herein. In some examples, aspects of the operations of 2025 may be performed by a OAM transmission manager 1035 as described with reference to FIG. 10.

At 2030, the method may include transmitting one or more messages to the second device using one or more transmitter circles according to a power loading scheme based on the set of multiple channel gain measurements, the power loading scheme associated with one or more orbital angular momentum modes of the set of multiple orbital angular momentum modes. The operations of 2030 may be performed in accordance with examples as disclosed herein. In some examples, aspects of the operations of 2030 may be performed by a power loading component 1055 as described with reference to FIG. 10.

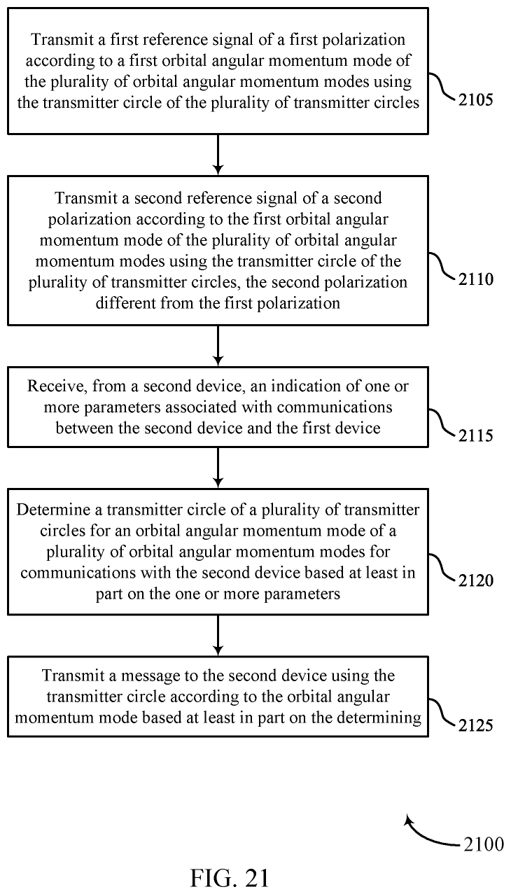

FIG. 21 shows a flowchart illustrating a method 2100 that supports orbital angular momentum transmitter circle selection in accordance with aspects of the present disclosure. The operations of the method 2100 may be implemented by a base station or a UE or its components as described herein. For example, the operations of the method 2100 may be performed by a base station 105 or a UE 115 as described with reference to FIGS. 1 through 12. In some examples, a base station or a UE may execute a set of instructions to control the functional elements of the base station or the UE to perform the described functions. Additionally or alternatively, the base station or the UE may perform aspects of the described functions using special-purpose hardware.

At 2105, the method may include transmitting a first reference signal of a first polarization according to a first orbital angular momentum mode of the set of multiple orbital angular momentum modes using the transmitter circle of the set of multiple transmitter circles. The operations of 2105 may be performed in accordance with examples as disclosed herein. In some examples, aspects of the operations of 2105 may be performed by a reference signal manager 1050 as described with reference to FIG. 10.

At 2110, the method may include transmitting a second reference signal of a second polarization according to the first orbital angular momentum mode of the set of multiple orbital angular momentum modes using the transmitter circle of the set of multiple transmitter circles, the second polarization different from the first polarization. The operations of 2110 may be performed in accordance with examples as disclosed herein. In some examples, aspects of the operations of 2110 may be performed by a reference signal manager 1050 as described with reference to FIG. 10.

At 2115, the method may include receiving, from a second device, an indication of one or more parameters associated with communications between the second device and the first device. The operations of 2115 may be performed in accordance with examples as disclosed herein. In some examples, aspects of the operations of 2115 may be performed by a parameter reception manager 1025 as described with reference to FIG. 10.

At 2120, the method may include determining a transmitter circle of a set of multiple transmitter circles for an orbital angular momentum mode of a set of multiple orbital angular momentum modes for communications with the second device based on the one or more parameters. The operations of 2120 may be performed in accordance with examples as disclosed herein. In some examples, aspects of the operations of 2120 may be performed by a transmitter circle determination manager 1030 as described with reference to FIG. 10.

At 2125, the method may include transmitting a message to the second device using the transmitter circle according to the orbital angular momentum mode based on the determining. The operations of 2125 may be performed in accordance with examples as disclosed herein. In some examples, aspects of the operations of 2125 may be performed by a OAM transmission manager 1035 as described with reference to FIG. 10.

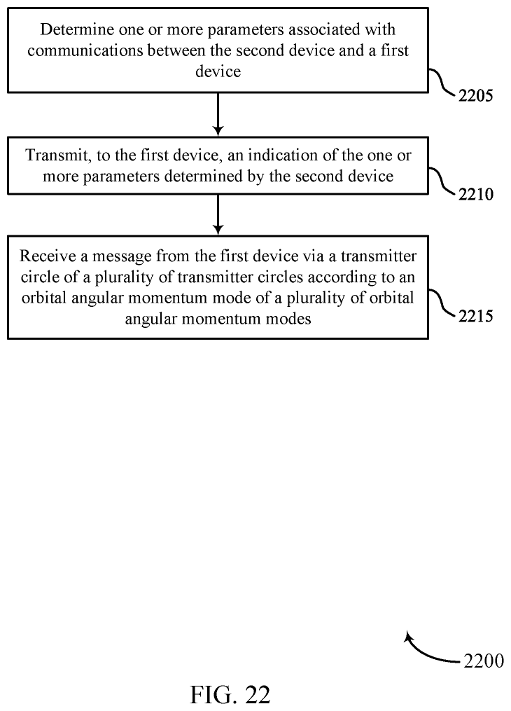

FIG. 22 shows a flowchart illustrating a method 2200 that supports orbital angular momentum transmitter circle selection in accordance with aspects of the present disclosure. The operations of the method 2200 may be implemented by a UE or a base station or its components as described herein. For example, the operations of the method 2200 may be performed by a UE 115 or a base station 105 as described with reference to FIGS. 1 through 7 and 13 through 17. In some examples, a UE or a base station may execute a set of instructions to control the functional elements of the UE or the base station to perform the described functions. Additionally or alternatively, the UE or the base station may perform aspects of the described functions using special-purpose hardware.

At 2205, the method may include determining one or more parameters associated with communications between the second device and a first device. The operations of 2205 may be performed in accordance with examples as disclosed herein. In some examples, aspects of the operations of 2205 may be performed by a parameter determination component 1540 as described with reference to FIG. 15.

At 2210, the method may include transmitting, to the first device, an indication of the one or more parameters determined by the second device. The operations of 2210 may be performed in accordance with examples as disclosed herein. In some examples, aspects of the operations of 2210 may be performed by a parameter indication component 1545 as described with reference to FIG. 15.

At 2215, the method may include receiving a message from the first device via a transmitter circle of a set of multiple transmitter circles according to an orbital angular momentum mode of a set of multiple orbital angular momentum modes. The operations of 2215 may be performed in accordance with examples as disclosed herein. In some examples, aspects of the operations of 2215 may be performed by a OAM transmission manager 1535 as described with reference to FIG. 15.

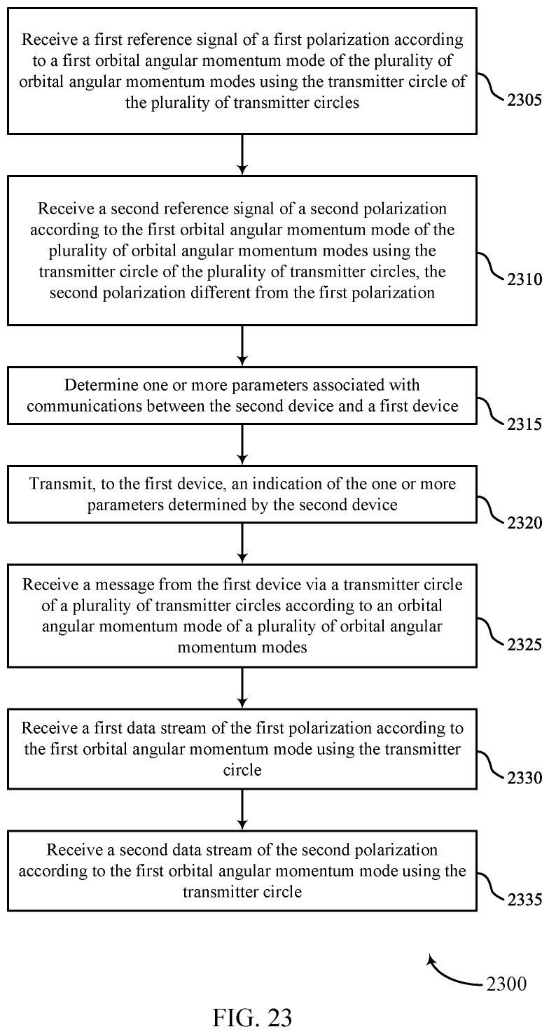

FIG. 23 shows a flowchart illustrating a method 2300 that supports orbital angular momentum transmitter circle selection in accordance with aspects of the present disclosure. The operations of the method 2300 may be implemented by a UE or a base station or its components as described herein. For example, the operations of the method 2300 may be performed by a UE 115 or a base station 105 as described with reference to FIGS. 1 through 7 and 13 through 17. In some examples, a UE or a base station may execute a set of instructions to control the functional elements of the UE or the base station to perform the described functions. Additionally or alternatively, the UE or the base station may perform aspects of the described functions using special-purpose hardware.

At 2305, the method may include receiving a first reference signal of a first polarization according to a first orbital angular momentum mode of the set of multiple orbital angular momentum modes using the transmitter circle of the set of multiple transmitter circles. The operations of 2305 may be performed in accordance with examples as disclosed herein. In some examples, aspects of the operations of 2305 may be performed by a reference signal manager 1550 as described with reference to FIG. 15.

At 2310, the method may include receiving a second reference signal of a second polarization according to the first orbital angular momentum mode of the set of multiple orbital angular momentum modes using the transmitter circle of the set of multiple transmitter circles, the second polarization different from the first polarization. The operations of 2310 may be performed in accordance with examples as disclosed herein. In some examples, aspects of the operations of 2310 may be performed by a reference signal manager 1550 as described with reference to FIG. 15.

At 2315, the method may include determining one or more parameters associated with communications between the second device and a first device. The operations of 2315 may be performed in accordance with examples as disclosed herein. In some examples, aspects of the operations of 2315 may be performed by a parameter determination component 1540 as described with reference to FIG. 15.

At 2320, the method may include transmitting, to the first device, an indication of the one or more parameters determined by the second device. The operations of 2320 may be performed in accordance with examples as disclosed herein. In some examples, aspects of the operations of 2320 may be performed by a parameter indication component 1545 as described with reference to FIG. 15.

At 2325, the method may include receiving a message from the first device via a transmitter circle of a set of multiple transmitter circles according to an orbital angular momentum mode of a set of multiple orbital angular momentum modes. The operations of 2325 may be performed in accordance with examples as disclosed herein. In some examples, aspects of the operations of 2325 may be performed by a OAM transmission manager 1535 as described with reference to FIG. 15.

At 2330, the method may include receiving a first data stream of the first polarization according to the first orbital angular momentum mode using the transmitter circle. The operations of 2330 may be performed in accordance with examples as disclosed herein. In some examples, aspects of the operations of 2330 may be performed by a data stream receiver 1570 as described with reference to FIG. 15.

At 2335, the method may include receiving a second data stream of the second polarization according to the first orbital angular momentum mode using the transmitter circle. The operations of 2335 may be performed in accordance with examples as disclosed herein. In some examples, aspects of the operations of 2335 may be performed by a data stream receiver 1570 as described with reference to FIG. 15.

The following provides an overview of aspects of the present disclosure:

Aspect 1: A method for wireless communications at a first device, comprising: receiving, from a second device, an indication of one or more parameters associated with communications between the second device and the first device; determining a transmitter circle of a plurality of transmitter circles for an OAM mode of a plurality of OAM modes for communications with the second device based at least in part on the one or more parameters; and transmitting a message to the second device using the transmitter circle according to the OAM mode based at least in part on the determining.

Aspect 2: The method of aspect 1, further comprising: transmitting a reference signal using a center transmitter circle of the plurality of transmitter circles, the center transmitter circle being at a center of one or more of the plurality of transmitter circles, wherein the transmitter circle is determined based at least in part on the reference signal.

Aspect 3: The method of aspect 2, wherein transmitting the reference signal comprises: transmitting the reference signal using a set of reference signal resources for the reference signal, wherein the reference signal, the set of reference signal resources, or both are unique to the transmitter circle.

Aspect 4: The method of any of aspects 1 through 3, further comprising: transmitting one or more reference signals according to a respective OAM mode of the plurality of OAM modes via each transmitter circle of the plurality of transmitter circles; receiving a plurality of channel gain measurements, each channel gain measurement associated with a respective OAM mode-transmitter circle pairing based at least in part on the one or more reference signals; and transmitting one or more messages to the second device using one or more transmitter circles according to a power loading scheme based at least in part on the plurality of channel gain measurements, the power loading scheme associated with one or more OAM modes of the plurality of OAM modes.

Aspect 5: The method of any of aspects 1 through 4, further comprising: transmitting a first reference signal of a first polarization according to a first OAM mode of the plurality of OAM modes using the transmitter circle of the plurality of transmitter circles; and transmitting a second reference signal of a second polarization according to the first OAM mode of the plurality of OAM modes using the transmitter circle of the plurality of transmitter circles, the second polarization different from the first polarization.

Aspect 6: The method of aspect 5, further comprising: transmitting a first data stream of the first polarization according to the first OAM mode using the transmitter circle; and transmitting a second data stream of the second polarization according to the first OAM mode using the transmitter circle.

Aspect 7: The method of any of aspects 5 through 6, wherein the transmitter circle comprises a plurality of antenna sub-arrays, each antenna sub-array comprising a first antenna element associated with transmissions of the first polarization and a second antenna element associated with transmissions of the second polarization; and each of the first and second reference signals is transmitted using a respective antenna sub-array of the plurality of antenna sub-arrays.

Aspect 8: The method of any of aspects 1 through 7, wherein the OAM mode is associated with mode 0; and the transmitter circle comprises at least a center transmitter circle of the plurality of transmitter circles, the center transmitter circle being at a center of one or more of the plurality of transmitter circles.

Aspect 9: The method of any of aspects 1 through 8, further comprising: transmitting one or more reference signals according to a respective OAM mode of the plurality of OAM modes via each transmitter circle of the plurality of transmitter circles.

Aspect 10: The method of aspect 9, further comprising: transmitting an indication of an association between a set of reference signal resources for the one or more reference signals and a respective OAM mode-transmitter circle pairing.

Aspect 11: The method of any of aspects 9 through 10, wherein receiving the indication of one or more parameters comprises: receiving an indication of a respective transmitter circle for each OAM mode of the plurality of OAM modes based at least in part on the one or more reference signals.

Aspect 12: The method of aspect 11, further comprising: receiving a plurality of channel gain measurements, each channel gain measurement associated with a respective OAM mode-transmitter circle pairing.

Aspect 13: The method of aspect 12, wherein the transmitter circle of the plurality of transmitter circles for the OAM mode of the plurality of OAM modes is determined based at least in part on the indication of the transmitter circle selected for each OAM mode, or the plurality of channel gain measurements, or both.

Aspect 14: The method of any of aspects 9 through 13, wherein receiving the indication of one or more parameters comprises: receiving a channel gain measurement associated with each transmitted reference signal.

Aspect 15: The method of any of aspects 9 through 14, wherein receiving the indication of one or more parameters comprises: receiving a channel gain measurement associated with each mode, wherein the channel gain measurement is a highest channel gain measurement associated with the mode.

Aspect 16: The method of any of aspects 1 through 15, wherein receiving the indication of the one or more parameters comprises: receiving an indication of one or more channel parameters, or one or more receiver device parameters, or both.

Aspect 17: The method of aspect 16, wherein the one or more channel parameters comprise a path loss measurement between the second device and the first device, or a communication distance between the second device and the first device, or both.

Aspect 18: The method of any of aspects 16 through 17, wherein the one or more receiver device parameters comprises a radius of one or more receiver circles of the second device.

Aspect 19: The method of any of aspects 1 through 18, further comprising: calculating a channel gain for each OAM mode-transmitter circle pairing based at least in part on the one or more parameters.

Aspect 20: The method of aspect 19, wherein the transmitter circle of the plurality of transmitter circles for the OAM mode of the plurality of OAM modes is determined based at least in part on the channel gain calculated for each for a respective OAM mode-transmitter circle pairing.

Aspect 21: The method of any of aspects 1 through 20, wherein receiving the indication of the one or more parameters comprises: receiving, from the second device, the indication of the one or more parameters via an RRC message, a MAC-CE message, a DCI message, a UCI message, a SCI message, or a combination thereof.

Aspect 22: The method of any of aspects 1 through 21, further comprising: transmitting, to the second device, a configuration message indicating the transmitter circle determined for the OAM mode.

Aspect 23: A method for wireless communications at a second device, comprising: determining one or more parameters associated with communications between the second device and a first device; transmitting, to the first device, an indication of the one or more parameters determined by the second device; and receiving a message from the first device via a transmitter circle of a plurality of transmitter circles according to an OAM mode of a plurality of OAM modes.

Aspect 24: The method of aspect 23, further comprising: receiving a reference signal via a center transmitter circle of the plurality of transmitter circles, the center transmitter circle being at a center of one or more of the plurality of transmitter circles, wherein the one or more parameters are based at least in part on the reference signal.

Aspect 25: The method of aspect 24, wherein receiving the reference signal comprises: receiving the reference signal using a set of reference signal resources for the reference signal, wherein the reference signal, the set of reference signal resources, or both are unique to the transmitter circle.

Aspect 26: The method of any of aspects 23 through 25, further comprising: receiving one or more reference signals according to a respective OAM mode of the plurality of OAM modes via each transmitter circle of the plurality of transmitter circles; transmitting a plurality of channel gain measurements, each channel gain measurement associated with a respective OAM mode-transmitter circle pairing based at least in part on the one or more reference signals; and receiving one or more messages from the second device using one or more transmitter circles according to a power loading scheme based at least in part on the plurality of channel gain measurements, the power loading scheme associated with one or more OAM modes of the plurality of OAM modes.

Aspect 27: The method of any of aspects 23 through 26, further comprising: receiving a first reference signal of a first polarization according to a first OAM mode of the plurality of OAM modes using the transmitter circle of the plurality of transmitter circles; and receiving a second reference signal of a second polarization according to the first OAM mode of the plurality of OAM modes using the transmitter circle of the plurality of transmitter circles, the second polarization different from the first polarization.

Aspect 28: The method of aspect 27, further comprising: receiving a first data stream of the first polarization according to the first OAM mode using the transmitter circle; and receiving a second data stream of the second polarization according to the first OAM mode using the transmitter circle.

Aspect 29: The method of any of aspects 23 through 28, wherein the OAM mode is associated with mode 0; and the transmitter circle comprises at least a center transmitter circle of the plurality of transmitter circles, the center transmitter circle being at a center of one or more of the plurality of transmitter circles.

Aspect 30: The method of any of aspects 23 through 29, further comprising: receiving one or more reference signals according to a respective OAM mode of the plurality of OAM modes via each transmitter circle of the plurality of transmitter circles.

Aspect 31: The method of aspect 30, further comprising: receiving an indication of an association between a set of reference signal resources for the one or more reference signals and a respective OAM mode-transmitter circle pairing.

Aspect 32: The method of any of aspects 30 through 31, further comprising: calculating a channel gain measurement for each reference signal received by the second device, the channel gain measurement associated with an OAM mode-transmitter circle pairing.

Aspect 33: The method of aspect 32, further comprising: selecting a transmitter circle of the plurality of transmitter circles for each OAM mode of the plurality of OAM modes based at least in part on the channel gain measurement calculated for each reference signal received by the second device.

Aspect 34: The method of any of aspects 32 through 33, wherein transmitting the indication of the one or more parameters comprises: transmitting an indication of a respective transmitter circle selected for each OAM mode of the plurality of OAM modes.

Aspect 35: The method of any of aspects 32 through 34, wherein transmitting the indication of the one or more parameters comprises: transmitting the channel gain measurement associated with each received reference signal.

Aspect 36: The method of any of aspects 32 through 35, wherein transmitting the indication of the one or more parameters comprises: transmitting the channel gain measurement associated with each mode, wherein the channel gain measurement is a highest channel gain measurement associated with the mode.

Aspect 37: The method of any of aspects 23 through 36, further comprising: determining one or more channel parameters, one or more receiver device parameters, or both.

Aspect 38: The method of aspect 37, wherein transmitting the indication of the one or more parameters comprises: transmitting an indication of the one or more channel parameters, or the one or more receiver device parameters, or both.

Aspect 39: The method of any of aspects 37 through 38, wherein the one or more channel parameters comprises a path loss measurement between the second device and the first device, or a communication distance between the second device and the first device, or both, and wherein the one or more receiver device parameters comprises a radius of one or more receiver circles of the second device.

Aspect 40: The method of any of aspects 23 through 39, wherein transmitting the indication of the one or more parameters comprises: transmitting, to the first device, the indication of the one or more parameters via an RRC message, a MAC-CE message, a DCI message, a UCI message, a SCI message, or a combination thereof.

Aspect 41: The method of any of aspects 23 through 40, further comprising: receiving, from the first device, a configuration message indicating OAM mode-transmitter circle pairings, wherein the second device receives the message based at least in part on the configuration message.

Aspect 42: An apparatus for wireless communications at a first device, comprising a processor; memory coupled with the processor; and instructions stored in the memory and executable by the processor to cause the apparatus to perform a method of any of aspects 1 through 22.

Aspect 43: An apparatus for wireless communications at a first device, comprising at least one means for performing a method of any of aspects 1 through 22.

Aspect 44: A non-transitory computer-readable medium storing code for wireless communications at a first device, the code comprising instructions executable by a processor to perform a method of any of aspects 1 through 22.

Aspect 45: An apparatus for wireless communications at a second device, comprising a processor; memory coupled with the processor; and instructions stored in the memory and executable by the processor to cause the apparatus to perform a method of any of aspects 23 through 41.

Aspect 46: An apparatus for wireless communications at a second device, comprising at least one means for performing a method of any of aspects 23 through 41.

Aspect 47: A non-transitory computer-readable medium storing code for wireless communications at a second device, the code comprising instructions executable by a processor to perform a method of any of aspects 23 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first device, comprising:
receiving, from a second device, an indication of one or more parameters associated with communications between the second device and the first device;
determining a transmitter circle of a plurality of transmitter circles for an orbital angular momentum mode of a plurality of orbital angular momentum modes for communications with the second device based at least in part on the one or more parameters;
and transmitting a message to the second device using the transmitter circle according to the orbital angular momentum mode based at least in part on the determining.

2. The method of claim 1, further comprising:
transmitting a reference signal using a center transmitter circle of the plurality of transmitter circles, the center transmitter circle being at a center of one or more of the plurality of transmitter circles, wherein the transmitter circle is determined based at least in part on the reference signal.

3. The method of claim 2, wherein transmitting the reference signal comprises:
transmitting the reference signal using a set of reference signal resources for the reference signal, wherein the reference signal, the set of reference signal resources, or both are unique to the transmitter circle.

4. The method of claim 1, further comprising:
transmitting one or more reference signals according to a respective orbital angular momentum mode of the plurality of orbital angular momentum modes via each transmitter circle of the plurality of transmitter circles;
receiving a plurality of channel gain measurements, each channel gain measurement associated with a respective orbital angular momentum mode-transmitter circle pairing based at least in part on the one or more reference signals; and
transmitting one or more messages to the second device using one or more transmitter circles according to a power loading scheme based at least in part on the plurality of channel gain measurements, the power loading scheme associated with one or more orbital angular momentum modes of the plurality of orbital angular momentum modes.

5. The method of claim 1, further comprising:
transmitting a first reference signal of a first polarization according to a first orbital angular momentum mode of the plurality of orbital angular momentum modes using the transmitter circle of the plurality of transmitter circles; and
transmitting a second reference signal of a second polarization according to the first orbital angular momentum mode of the plurality of orbital angular momentum modes using the transmitter circle of the plurality of transmitter circles, the second polarization different from the first polarization.

6. The method of claim 5, further comprising:
transmitting a first data stream of the first polarization according to the first orbital angular momentum mode using the transmitter circle; and
transmitting a second data stream of the second polarization according to the first orbital angular momentum mode using the transmitter circle.

7. The method of claim 5, wherein:
the transmitter circle comprises a plurality of antenna sub-arrays, each antenna sub-array comprising a first antenna element associated with transmissions of the first polarization and a second antenna element associated with transmissions of the second polarization; and
each of the first and second reference signals is transmitted using a respective antenna sub-array of the plurality of antenna sub-arrays.

8. The method of claim 1, wherein:
the orbital angular momentum mode is associated with mode 0; and
the transmitter circle comprises at least a center transmitter circle of the plurality of transmitter circles, the center transmitter circle being at a center of one or more of the plurality of transmitter circles.

9. The method of claim 1, further comprising:
transmitting one or more reference signals according to a respective orbital angular momentum mode of the plurality of orbital angular momentum modes via each transmitter circle of the plurality of transmitter circles.

10. The method of claim 9, further comprising:
transmitting an indication of an association between a set of reference signal resources for the one or more reference signals and a respective orbital angular momentum mode-transmitter circle pairing.

11. The method of claim 9, wherein receiving the indication of one or more parameters comprises:
receiving an indication of a respective transmitter circle for each orbital angular momentum mode of the plurality of orbital angular momentum modes based at least in part on the one or more reference signals.

12. The method of claim 11, further comprising:
receiving a plurality of channel gain measurements, each channel gain measurement associated with a respective orbital angular momentum mode-transmitter circle pairing.

13. The method of claim 12, wherein the transmitter circle of the plurality of transmitter circles for the orbital angular momentum mode of the plurality of orbital angular momentum modes is determined based at least in part on the indication of the transmitter circle selected for each orbital angular momentum mode, or the plurality of channel gain measurements, or both.

14. The method of claim 9, wherein receiving the indication of one or more parameters comprises:
receiving a channel gain measurement associated with each transmitted reference signal.

15. The method of claim 9, wherein receiving the indication of one or more parameters comprises:
receiving a channel gain measurement associated with each mode, wherein the channel gain measurement is a highest channel gain measurement associated with the mode.

16. The method of claim 1, wherein receiving the indication of the one or more parameters comprises:
receiving an indication of one or more channel parameters, or one or more receiver device parameters, or both.

17. The method of claim 16, wherein the one or more channel parameters comprise a path loss measurement between the second device and the first device, or a communication distance between the second device and the first device, or both.

18. The method of claim 16, wherein the one or more receiver device parameters comprises a radius of one or more receiver circles of the second device.

19. The method of claim 1, further comprising:
calculating a channel gain for each orbital angular momentum mode-transmitter circle pairing based at least in part on the one or more parameters.

20. The method of claim 19, wherein the transmitter circle of the plurality of transmitter circles for the orbital angular momentum mode of the plurality of orbital angular momentum modes is determined based at least in part on the channel gain calculated for each for a respective orbital angular momentum mode-transmitter circle pairing.

21. The method of claim 1, wherein receiving the indication of the one or more parameters comprises:
receiving, from the second device, the indication of the one or more parameters via a radio resource control message, a medium access control control element message, a downlink control information message, an uplink control information message, a sidelink control information message, or a combination thereof.

22. The method of claim 1, further comprising:
transmitting, to the second device, a configuration message indicating the transmitter circle determined for the orbital angular momentum mode.

23. A method for wireless communications at a second device, comprising:
determining one or more parameters associated with communications between the second device and a first device;
transmitting, to the first device, an indication of the one or more parameters determined by the second device; and
receiving a message from the first device via a transmitter circle of a plurality of transmitter circles according to an orbital angular momentum mode of a plurality of orbital angular momentum modes.

24. The method of claim 23, further comprising:
receiving a reference signal via a center transmitter circle of the plurality of transmitter circles, the center transmitter circle being at a center of one or more of the plurality of transmitter circles, wherein the one or more parameters are based at least in part on the reference signal.

25. The method of claim 24, wherein receiving the reference signal comprises:
receiving the reference signal using a set of reference signal resources for the reference signal, wherein the reference signal, the set of reference signal resources, or both are unique to the transmitter circle.

26. The method of claim 23, further comprising:
receiving one or more reference signals according to a respective orbital angular momentum mode of the plurality of orbital angular momentum modes via each transmitter circle of the plurality of transmitter circles;
transmitting a plurality of channel gain measurements, each channel gain measurement associated with a respective orbital angular momentum mode-transmitter circle pairing based at least in part on the one or more reference signals; and
receiving one or more messages from the second device using one or more transmitter circles according to a power loading scheme based at least in part on the plurality of channel gain measurements, the power loading scheme associated with one or more orbital angular momentum modes of the plurality of orbital angular momentum modes.

27. The method of claim 23, further comprising:
receiving a first reference signal of a first polarization according to a first orbital angular momentum mode of the plurality of orbital angular momentum modes using the transmitter circle of the plurality of transmitter circles; and
receiving a second reference signal of a second polarization according to the first orbital angular momentum mode of the plurality of orbital angular momentum modes using the transmitter circle of the plurality of transmitter circles, the second polarization different from the first polarization.

28. The method of claim 27, further comprising:
receiving a first data stream of the first polarization according to the first orbital angular momentum mode using the transmitter circle; and
receiving a second data stream of the second polarization according to the first orbital angular momentum mode using the transmitter circle.

29. An apparatus for wireless communications at a first device, comprising:
a processor;
memory coupled with the processor; and
instructions stored in the memory and executable by the processor to cause the apparatus to:
receive, from a second device, an indication of one or more parameters associated with communications between the second device and the first device;
determine a transmitter circle of a plurality of transmitter circles for an orbital angular momentum mode of a plurality of orbital angular momentum modes for communications with the second device based at least in part on the one or more parameters; and
transmit a message to the second device using the transmitter circle according to the orbital angular momentum mode based at least in part on the determining.

30. An apparatus for wireless communications at a second device, comprising:
a processor;
memory coupled with the processor; and
instructions stored in the memory and executable by the processor to cause the apparatus to:
determine one or more parameters associated with communications between the second device and a first device;
transmit, to the first device, an indication of the one or more parameters determined by the second device; and
receive a message from the first device via a transmitter circle of a plurality of transmitter circles according to an orbital angular momentum mode of a plurality of orbital angular momentum modes.
